(19) United States
(12) Patent Application Publication
(10) Pub. No.: US 2026/0236596 A1
(43) Pub. Date: Aug. 13, 2026

(54) PRE-EXECUTION AUTHORITATIVE DATA BINDING FOR GENERATIVE MACHINE LEARNING SYSTEMS

(71) Applicant: MAI LABS LLC, North Bay Village, FL (US)

(72) Inventor: Christopher P. Maiorana, North Bay Village, FL (US)

(21) Appl. No.: 19/639,076

(22) Filed: Apr. 3, 2026

Related U.S. Application Data
(60) Provisional application No. 63/906,669, filed on Oct. 28, 2025.
(60) Provisional application No. 63/907,345, filed on Oct. 29, 2025.
(60) Provisional application No. 63/910,206, filed on Nov. 3, 2025.
(60) Provisional application No. 63/911,540, filed on Nov. 5, 2025.
(60) Provisional application No. 63/912,463, filed on Nov. 6, 2025.
(60) Provisional application No. 63/914,590, filed on Nov. 10, 2025.
(60) Provisional application No. 63/920,698, filed on Nov. 19, 2025.
(60) Provisional application No. 63/929,125, filed on Dec. 2, 2025.
(60) Provisional application No. 63/939,903, filed on Dec. 12, 2025.
(60) Provisional application No. 63/972,622, filed on Jan. 30, 2026.
(60) Provisional application No. 63/974,179, filed on Feb. 2, 2026.
(60) Provisional application No. 63/983,780, filed on Feb. 16, 2026.
(60) Provisional application No. 64/005,696, filed on Mar. 14, 2026.
(60) Provisional application No. 64/020,279, filed on Mar. 28, 2026.
(60) Provisional application No. 64/026,578, filed on Apr. 2, 2026.

(51) Int. Cl. G06F 21/60; G06F 21/62

(52) U.S. Cl. CPC G06F 21/604; G06F 21/6245; G06F 21/629

(57) ABSTRACT

A computer-implemented method for enforcing authoritative data binding in a generative machine learning system, the method comprising: receiving an input comprising a request from an end user associated with a structured output comprising one or more predefined semantic roles and a data source, identifying at least one of the predefined semantic roles as an authoritatively bound role prior to execution of the generative machine learning system, retrieving a value corresponding to the authoritatively bound role from the data source, populating the authoritatively bound role with the value, providing the populated authoritatively bound role to the generative machine learning system as part of an execution context for generating the structured output, and executing the generative machine learning system to generate remaining portions of the structured output while maintaining the populated authoritatively bound role as fixed.

This application relates to U.S. Provisional Application No. 63/906,669, filed on Oct. 28, 2025. This application also relates to U.S. Provisional Application No. 63/907,345, filed on Oct. 29, 2025. This application also relates to U.S. Provisional Application No. 63/910,206, filed on Nov. 3, 2025. This application also relates to U.S. Provisional Application No. 63/911,540, filed on Nov. 5, 2025. This application also relates to U.S. Provisional Application No. 63/912,463, filed on Nov. 6, 2025. This application also relates to U.S. Provisional Application No. 63/914,590, filed on Nov. 10, 2025. This application also relates to U.S. Provisional Application No. 63/920,698, filed on Nov. 19, 2025. This application also relates to U.S. Provisional Application No. 63/929,125, filed on Dec. 2, 2025. This application also relates to U.S. Provisional Application No. 63/939,903, filed on Dec. 12, 2025. This application also relates to U.S. Provisional Application No. 63/972,622, filed on Jan. 30, 2026. This application also relates to U.S. Provisional Application No. 63/974,179, filed on Feb. 2, 2026. This application also relates to U.S. Provisional Application No. 63/983,780, filed on Feb. 16, 2026. This application also relates to U.S. Provisional Application No. 64/005,696, filed on Mar. 14, 2026. This application also relates to U.S. Provisional Application No. 64/020,279, filed on Mar. 28, 2026. This application also relates to U.S. Provisional Application No. 64/026,578, filed on Apr. 2, 2026. Each mentioned application is hereby incorporated by reference in its entirety.

### FIELD OF THE INVENTION

The invention relates to generative content from large language models generally and, more particularly, to a method and/or apparatus for implementing pre-execution authoritative data binding for generative machine learning systems.

### BACKGROUND

Use of generative artificial intelligence (AI) is becoming increasingly popular. AI technology is developing rapidly. Training, updating and deploying AI technology is expensive. In order to monetize AI technology, while still investing on improvements, many AI systems are available but only have limited guardrails. Even if AI models become extremely accurate, conventional AI technology are probabilistic systems. A well-known shortcoming of probabilistic systems is that they can occasionally produce an incorrect value (i.e., hallucinations, AI slop, etc.). While probabilistic reasoning can provide flexible language generation, probabilistic reasoning also means that generated outputs can include inferred or extrapolated information that is not directly grounded in authoritative data. Generative models are optimized for probabilistic inference, and not authoritative data retrieval. Many generative AI models err on the side of providing output, even if the requested information is unavailable. In contexts where the output values must be exact (i.e., such as a patient medical records, medical prescription dosages, legal citations, financial transactions, etc.) generative AI models may inject probabilistically inferred content where a deterministic resolution is required. End users often rely on prompt engineering to attempt to retrieve accurate information, or multiple requests to seek more accurate information. However, generative models still rely on probabilistic inference.

It would be desirable to implement pre-execution authoritative data binding for generative machine learning systems.

### SUMMARY

The present invention is one application in a pipeline of filings directed to a comprehensive architecture for governing the behavior of generative artificial intelligence systems. Unconstrained probabilistic inference produces a spectrum of output failures that extend well beyond outright hallucination. At the extreme, a generative model fabricates content with no basis in fact. A more pervasive and dangerous failure mode is near-hallucination, where the artificial intelligence model generates output that is plausible, internally consistent, and confidently stated and yet diverges from authoritative reality in ways that are difficult to detect and catastrophic in high-stakes contexts. For example, near-hallucinations may be a patient weight that is close but wrong, a legal citation that exists but is misquoted, a financial parameter that reflects training data rather than the current record, etc.

Another failure mode that may be recognizable to anyone who has deployed a generative system in a production environment is when the artificial intelligence model is not hallucinating and is not obviously wrong, however the output simply seems off. For example, the reasoning drifts, the response addresses a slightly different question than the one asked, the output is technically accurate but contextually misaligned, or the model applies general knowledge where specific authoritative information was required and available. Such failures may be the most difficult to catch precisely because the failures do not trigger obvious error conditions, can pass review and may propagate downstream. In regulated environments, the errors can create liability. In autonomous agent workflows, the errors may produce cascading errors that are expensive to unwind.

Generally, the failures occur not because the model is broken but because probabilistic inference is the wrong tool for deterministic retrieval. Conventional systems have no architectural mechanism to enforce the boundary between probabilistic inference and deterministic retrieval. The architecture addressed across this pipeline of filings governs the boundary between inference and deterministic retrieval at every level of the reasoning process (e.g., execution authority, authoritative data binding, reasoning state management, epistemic input control, and/or collaborative reasoning governance). The architecture may ensure that probabilistic inference operates only where inference is appropriate, and is structurally prohibited where deterministic retrieval is required.

The present application is directed to a computer-implemented method for enforcing authoritative data binding in a generative machine learning system, the method comprising: receiving an input comprising a request from an end user associated with a structured output comprising one or more predefined semantic roles and a data source, identifying at least one of the predefined semantic roles as an authoritatively bound role prior to execution of the generative machine learning system, retrieving a value corresponding to the authoritatively bound role from the data source, populating the authoritatively bound role with the value, providing the populated authoritatively bound role to the generative machine learning system as part of an execution context for generating the structured output, and executing the generative machine learning system to generate remaining portions of the structured output while maintaining the populated authoritatively bound role as fixed.

### BRIEF DESCRIPTION OF THE FIGURES

Embodiments of the invention will be apparent from the following detailed description and the appended claims and drawings.

FIG. 1 is a block diagram illustrating an example embodiment of the present invention.

FIG. 2 is a block diagram illustrating a two-pass governance layer.

FIG. 3 is a block diagram illustrating architectural input confinement.

FIG. 4 is a block diagram illustrating deterministic role enforcement.

FIG. 5 is a flow diagram illustrating a method for governing input to enable a generative AI engine to populate a structured output with validated content that is bound to an authoritative source.

FIG. 6 is a block diagram illustrating authoritative semantic role binding for deterministic generative execution.

FIG. 7 is a flow diagram illustrating a method for identifying authoritatively bound semantic roles in response to analyzing a request.

FIG. 8 is a flow diagram illustrating a method for classifying a role value attribute for an authoritatively bound semantic role.

FIG. 9 is a block diagram illustrating a memory buffer architecture for a governance layer.

FIG. 10 is a block diagram illustrating epistemic tagging control.

FIG. 11 is a block diagram illustrating inference distance control for probabilistic reasoning systems.

FIG. 12 is a flow diagram illustrating a method for pre-filtering output content in response to a divergence from an authoritative source.

### DETAILED DESCRIPTION OF THE EMBODIMENTS

Embodiments of the present invention include providing pre-execution authoritative data binding for generative machine learning systems that may (i) provide architectural separation between model training and model governance, (ii) implement input-side conditioning for generative systems, (iii) enable runtime governance of generative reasoning, (iv) provide an architectural overlay as an alternative to model replacement, (v) reduce costs and compute requirements for retraining models, (vi) control reasoning instances at the execution level, (vii) provide a safety and/or accuracy overlay independent of the alignment of a model, (viii) ensure deployment stability across multiple domains, (ix) provide constraints for generative models, (x) override probabilistic generation, and/or (xi) be implemented as one or more integrated circuits.

Embodiments of the present invention may be configured to ensure probabilistic completion is subordinated to deterministic injection for generative artificial intelligence (AI) model output. Generally, generative AI models (e.g., a large language model (LLM)) perform probabilistic reasoning in response to an input prompt to generate output. Probabilistic reasoning may generate content that may be incorrect, inaccurate and/or fabricated. Various tasks may demand varying levels of accuracy for the generated output of an AI model. Ensuring that probabilistic completion may be subordinated to deterministic injection may enable the generative AI model to perform probabilistic reasoning with content guardrails. For example, the generative model may be constrained from having an authority to supply probabilistic output for protected output values. The protected output values may be restricted to values that may be validated from authoritative sources before generation may proceed.

Embodiments of the present invention may be configured to resolve system constraints before content generation. After the system constraints have been resolved, then the AI model may generate content within the defined constraints. For example, when a semantic role requires authoritative resolution (e.g., defined as protected output), the system may retrieve and validate the value first and then the model may generate content (e.g., text) around and/or in addition to the validated values (e.g., rather than inventing all of the content probabilistically). The probabilistic reasoning and the deterministic authority may be separate domains.

The system constraints may not necessarily restrict all of the content generated by the AI model. Generally, the AI model may generate explanations, narrative context, and/or reasoning chains. However, for certain semantic roles (e.g., protected content such as medical parameters, legal text, financial values, verified statistics, etc.) the model does not have permission to invent the value. Instead, the architecture of the present invention may inject deterministically retrieved data into the reasoning process and prevent the probabilistic model from substituting an inferred value.

Embodiments of the present invention may be configured to provide a deterministic boundary system for a reasoning engine. For example, the reasoning engine may operate within the deterministic boundary system. The AI model provides language generation and contextual reasoning, while the surrounding architecture may govern which semantic regions may be restricted to being resolved through authoritative data. The deterministic boundary system may enable the probabilistic intelligence to operate freely, while providing the structural boundaries that may ensure factual correctness for designated roles.

Embodiments of the present invention may be configured to operate and/or interact with semantic tokens (e.g., semantic units). The semantic units may not necessarily be identical to the final textual output produced by the generative AI engine. The semantic tokens may represent intermediate analytical elements that may be extracted from and/or associated with portions of generated content during a reasoning evaluation process. The generative AI engine may be configured to generate candidate text, narrative statements, structured reasoning steps, etc. In some embodiments, the generated content may be parsed and/or segmented into the semantic units that correspond to discrete assertions and/or factual propositions. Each semantic unit may be evaluated independently with respect to authoritative source material and/or retrieved evidence. The semantic tokens may function as analytical representations of meaning rather than merely raw output tokens from the generative AI engine. For example, the semantic tokens may correspond to a factual assertion, a numerical value, a citation statement and/or other information-bearing components that may be contained within the generated text. Embodiments of the present invention may be configured to apply classification operations (e.g., determining whether the assertion is citation-accurate, inferred, extrapolated, and/or unsupported).

The semantic tokens may be analyzed independently from the final textual output.

Embodiments of the present invention may be configured to attach epistemic metadata to specific informational elements without altering the AI model implemented by the AI engine. The final output may comprise the original text generated by the AI engine, but the system may maintain an associated metadata structure indicating the epistemic classification of the underlying semantic units. In some embodiments, semantic units determined to be inferred may be filtered, annotated, and/or removed before the final output generation. In some embodiments, the semantic classification may be preserved as metadata for downstream reasoning analysis and/or execution gating. The output of the generative engine may be treated as one source of candidate reasoning, while the semantic tokens may provide a structured representation that may be evaluated against authoritative sources and/or policy constraints.

Generative models may be generally optimized for probabilistic inference. End users may rely on generative models for authoritative data retrieval. Embodiments of the present invention may provide constraints and/or guardrails that may prevent probabilistic inferences from being used where the output desired may be deterministic and/or authoritative content.

Embodiments of the present invention may provide a governance architecture that may operate in conjunction with a generative reasoning engine to ensure that specific semantic roles within a generated output may be populated using verified data obtained from authoritative sources. The reasoning engine may generate candidate reasoning content and/or narrative explanations, while a governance framework may identify predefined semantic roles that may be determined to require deterministic population (e.g., data cited accurately from an authoritative source). For semantic roles that may require deterministic population, the governance framework system may retrieve parameter values from authoritative data sources and/or ensure that the generative reasoning engine retrieves parameters values from authoritative data sources, apply validation constraints appropriate to the role(s), and/or prevent probabilistic generation from supplying the value for the role(s). By separating probabilistic reasoning from deterministic parameter enforcement, the governance framework system may allow generative reasoning models to perform analytical and/or explanatory functions while ensuring that critical factual parameters may be populated using verified information. Embodiments of the present invention may enable reliable operation across a wide range of generative models while preserving the accuracy required in applications where specific values must correspond to authoritative data.

Embodiments of the present invention may relate to an artificial intelligence governance architecture that may operate at a level of reasoning conditions rather than output correction. Conventional large language model systems generate outputs first and attempt to evaluate, filter, and/or correct the outputs after generation. In contrast, the architecture of the present invention may govern what reasoning is permitted to occur, when reasoning is allowed to proceed, and/or which information may influence the reasoning before inference is performed.

Embodiments of the present invention may separate execution from commitment. A reasoning process (e.g., implemented by a large language model) may proceed without restriction, but the outputs of the reasoning process may not be permitted to propagate, trigger downstream actions, and/or produce irreversible effects unless defined authority conditions are satisfied. The defined authority conditions may enable continuous reasoning while preventing unverified outputs from affecting external systems.

Embodiments of the present invention may separate the reasoning processes from interaction processes. Reasoning may occur in parallel, in advance, and/or subsequent to user interaction. In one example, the reasoning may be reused without recomputation. As a result, response latency, computational redundancy, and/or context reconstruction overhead are materially reduced.

Embodiments of the present invention may maintain a validated cognitive state distinct from a conversational transcript. For example, rather than reconstructing prior reasoning from accumulated text of the conversational transcript, the system may capture and/or reuse a validated reasoning state in a form that may be inserted and/or rehydrated across sessions, agents, and/or environments without reintroducing unvalidated context.

In some embodiments, the system may maintain multiple concurrent interpretations of ambiguous inputs. Responses may be generated immediately based on a primary interpretation while alternative interpretations may be preserved and selectively activated without restarting the reasoning process. In multi-actor environments, the architecture may govern a transfer, aggregation, and/or isolation of cognitive representations across participants under defined consent, provenance, and/or scope constraints. For example, governing across participants may enable a coordinated reasoning without collapsing independent reasoning trajectories.

At the input level, embodiments of the present invention may enforce an epistemic boundary that may define which information may be admissible for a given reasoning operation. Information determined to be outside of the defined epistemic boundary may be structurally excluded from influencing the reasoning process, regardless of the availability to the system of the out of bounds information. Embodiments of the present invention may provide an architectural enforcement mechanism rather than a behavioral mechanism, which may enable verifiable and/or auditable reasoning outputs.

Enforcement mechanisms implemented by various embodiments of the present invention may form a governance substrate in which reasoning may be bounded, timed, applied to an appropriate state, and/or authority-conditioned prior to execution. For example, the enforcement mechanisms implemented may reduce a reliance on post-generation information correction and produce systems that may be more reliable, auditable, and computationally efficient across a wide range of deployment environments.

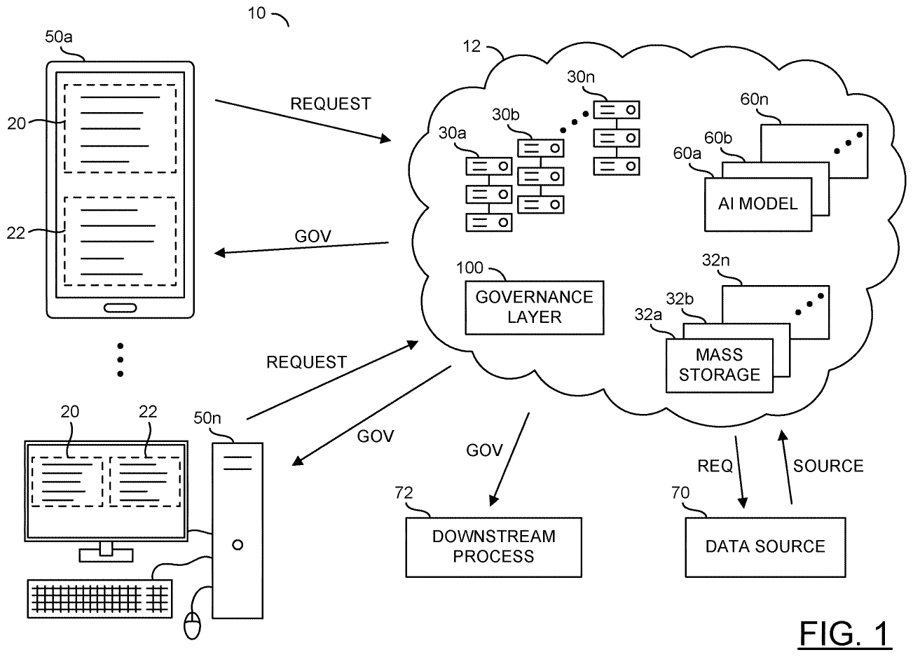

Referring to FIG. 1, a block diagram illustrating an example embodiment of the present invention is shown. A system 10 is shown. The system 10 may be an example cloud communication network. The cloud communication network 10 may enable interconnected devices to communicate with remote resources.

The cloud communication network 10 may comprise a cloud computing service 12 in communication with a number of client devices 50a-50n. The cloud communication network 10 may comprise a number of blocks (or circuits) 30a-30n, a number of blocks (or circuits) 32a-32n, a number of blocks (or circuits) 60a-60n and/or a block (or circuit) 100. The circuits 30a-30n may implement server computers. The circuits 32a-32n may comprise mass storage devices. The circuits 60a-60n may comprise AI models and/or AI engines. The circuit 100 may implement an apparatus and/or a system (e.g., a governance layer, content pre-filtering system, an output governance layer, etc.). The cloud communication network 10 may comprise other components (not shown). The number, type and/or arrangement of the components of the cloud communication network 10 may be varied according to the design criteria of a particular implementation.

The cloud computing service 12 may be configured to store data, retrieve and transmit stored data, process data and/or communicate with other devices. The server computers 30a-30n and/or the mass storage devices 32a-32n may be implemented as part of a cloud computing platform (e.g., distributed computing). In an example, the server computers 30a-30n and/or the mass storage devices 32a-32n may be implemented as a group of cloud-based, scalable server computers. By implementing a number of scalable servers, additional resources (e.g., power, processing capability, memory, etc.) may be available to process and/or store variable amounts of data. For example, the cloud computing service 12 may be configured to scale (e.g., provision resources) of the server computers 30a-30n and/or the mass storage devices 32a-32n based on demand. The cloud computing service 12 may implement scalable computing (e.g., cloud computing). The scalable computing may be available as a service to allow access to processing and/or storage resources without having to build infrastructure (e.g., the provider of the apparatus 100, the client devices 50a-50n and/or the AI engines 60a-60n may not have to build the infrastructure of the cloud computing service 12).

Each of the server computers 30a-30n may comprise memory and/or processors. Each of the mass storage devices 32a-32n may comprise storage devices (e.g., hard drives, solid state drives, etc.). The cloud computing service 12 may aggregate the resources provided by the server computers 30a-30n and/or the mass storage devices 32a-32n to provision resources based on demand. For example, cloud computing (e.g., processing) may be made available by provisioning the processing capabilities of the server computers 30a-30n. In another example, the storage capacity of the mass storage devices 32a-32n may enable the cloud computing service 12 to provide cloud storage services. The particular services available and/or the provision of the services of the cloud computing service 12 may be varied according to the design criteria of a particular implementation.

The cloud processing provided by the cloud computing service 12 may provide resources for implementing the AI engines 60a-60n. The AI engines 60a-60n may implement one or more machine learning models trained to generate natural language and/or structured reasoning outputs. For example, the machine learning models may comprise large language models (LLMs), transformer-based neural networks, vision-language models (VLMs), and/or other generative inference systems that may be capable of producing contextual responses based on input prompts and/or retrieved information. Generally, the AI engines 60a-60n may be configured to generate probabilistically inferred content. The particular types of models implemented by the AI engines 60a-60n may be varied according to the design criteria of a particular implementation.

The apparatus 100 may be implemented by the cloud computing service 12. In the example shown, the apparatus 100 may be shown as a separate component from the server computers 30a-30n, the mass storage devices 32a-32n and/or the AI engines 60a-60n for illustrative purposes. In some embodiments, the apparatus 100 may be integrated as part of one or more of the components of the cloud computing service 12. In one example, the apparatus 100 may comprise computer readable instructions that may be executable by the server computers 30a-30n in conjunction with the AI models 60a-60n. The operations and/or features provided by the apparatus 100 may be performed by the various resources provisioned by the cloud computing services 12. For example, the apparatus 100 may be implemented using various instruction sets (e.g., x86, x86-64, ARM, RISC-V, etc.) implemented by the processing devices (e.g., CPU, GPU, APU, NPU, etc.) of the server computers 30a-30n. The particular interactions of the apparatus 100 with the other components of the cloud computing service 12 may be varied according to the design criteria of a particular implementation.

The client devices 50a-50n may each be a computing device used by an end user. The client devices 50a-50n may be configured to receive input from the end user, communicate with external networks, store data, execute computer readable instructions, etc. For example, one or more of the client devices 50a-50n may comprise a smartphone, a tablet computing device, a desktop computer, a smartwatch, a smartphone, a laptop computer, a netbook computer, smart glasses, a vehicle infotainment system, etc. Generally, the client devices 50a-50n may comprise an output display, input peripherals (e.g., a keyboard, a touchscreen, a microphone, a mouse, a gamepad, etc.), a processor, a memory, etc. For example, the combination of the processor and the memory implemented by the client devices 50a-50n may enable the client devices 50a-50n to execute computer readable instructions (e.g., implement an operating system, execute programs/apps, receive/process input and generate output, etc.). The client devices 50a-50n may be configured to execute an operating system (e.g., Windows, MacOS, IOS, Linux, Android, Fushia, etc.). The client devices 50a-50n may be configured to implement processing devices such as a CPU, an APU, an NPU (e.g., an AI-accelerated processor) that may implement various instruction sets (e.g., x86, x86-64, ARM, RISC-V, etc.). In the example shown, the client device 50a may be a smartphone and the client device 50n may be a desktop computer. The type and/or implementation of the client devices 50a-50n may be varied according to the design criteria of a particular implementation.

The end user may generally be a person operating one or more of the client devices 50a-50n. In some embodiments, the end user may be a system (e.g., an automated system). In one example, an automated system may be programmed to make requests to the apparatus 100. In another example, the end user may be an AI controlled device. Whether the client devices 50a-50n are controlled directly by a person and/or an automated system may be varied according to the design criteria of a particular implementation.

The client devices 50a-50n are shown displaying content 20-22. In the example shown, the content 20-22 may be visually represented as content displayed on a screen. The content 20 may be an input. The content 22 may be an output. For example, the end user may provide the input content 20 to one of the client devices 50a-50n and the client devices 50a-50n may provide the output content 22 to the end user. The type of the content 20-22 may be varied according to the design criteria of a particular implementation.

The client devices 50a-50n are each shown generating a signal (e.g., REQUEST). The signal REQUEST may be communicated by the client devices 50a-50n to the cloud computing service 12. The signal REQUEST may comprise the input content 20 from the client devices 50a-50n. For example, the end user may provide the input content 20 to one or more of the client devices 50a-50n and the client devices 50a-50n may communicate the input content 20 to the cloud computing service 12. In the example of the cloud communication network 10 with the apparatus 100 and the AI engines 60a-60n, the signal REQUEST may comprise a query provided to the AI engines 60a-60n. For example, the end user may ask a natural language question as the input content 20 and the natural language question may be forwarded to the AI engines 60a-60n of the cloud computing service 12 to provide the answer.

The client devices 50a-50n are each shown receiving a signal (e.g., GOV). The signal GOV may be communicated by the cloud computing service 12 to the client devices 50a-50n. The signal GOV may comprise the output content 22 for the client devices 50a-50n. For example, the cloud computer service 12 may provide the output content 22 to one or more of the client devices 50a-50n and the client devices 50a-50n may display the output content 22 to the end user. In the example of the cloud communication network 10 with the apparatus 100 and the AI engines 60a-60n, the signal GOV may comprise a response to the query (e.g., a response to the signal REQUEST) generated by the AI engines 60a-60n. For example, the AI engines 60a-60n may provide the answer to the natural language question, which may be displayed by the client devices 50a-50n as the output content 22.

The cloud communication network 10 may further comprise a block (or circuit) 70 and/or a block (or circuit) 72. The circuit 70 may be a data source (e.g., an authoritative data source). The circuit 72 may be a downstream process. The data source 70 and/or the downstream process 72 may be configured to interact with the cloud computing service 12. For example, when providing the answer to the query received from the client devices 50a-50n, the apparatus 100 and/or the AI engines 60a-60n may further communicate with the data source 70 and/or the downstream process 72.

The data source 70 may be an authoritative data source. The authoritative data source 70 may be configured to receive a signal (e.g., REQ) and provide a signal (e.g., SOURCE). The signal SOURCE may be an input that may be used by the AI engines 60a-60n to provide the output GOV of the client devices 50a-50n and/or the downstream process 72.

The authoritative data source 70 may be configured to provide authoritative data. The signal SOURCE may comprise the authoritative data. The authoritative data may be distinct from probabilistically inferred data generated by the AI engines 60a-60n. The apparatus 100 may be configured to ensure that the authoritative data from the authoritative data source 70 is provided in response to the input provided by the client devices 50a-50n. For example, the authoritative data source 70 may provide ground truth data and/or data that may have deterministic authority.

The downstream process 72 may be a process and/or device that may use and/or rely on the output content 22. For example, the client devices 50a-50n may provide the input content 20 (e.g., the signal REQUEST), which may be used to provide the output content 22 (e.g., the signal GOV) that may be usable by the downstream process 72. The downstream process 72 may be configured to receive the signal GOV. Generally, the downstream process 72 may be agnostic to how the output content 22 of the signal GOV has been generated. For example, the downstream process 72 may be configured to use the data provided in the signal GOV without prior knowledge of how the data was acquired, whether the data is accurate, whether the data is reliable, etc. In one example, the downstream process 72 may be configured to communicate the output GOV back to the client devices 50a-50n. In another example, the downstream process 72 may save the output content 22 as a file on a computing device. In yet another example, the downstream process 72 may be an agentic response to the output content 22. In still another example, the downstream process 72 may comprise sending a prescription, approving a financial transaction, executing a treatment plan, filing a legal document, etc. The number and/or types of the downstream process 72 may be varied according to the design criteria of a particular implementation.

The apparatus 100 may be configured to control, filter, govern, etc. the data provided in the signal GOV. For example, without the apparatus 100, the output content 22 in the signal GOV may comprise inaccurate data, hallucinated data, near-hallucinated data, data resulting from AI model drift, unreliable data, etc. The apparatus 100 may be configured to bind the output of the AI engines 60a-60n to authoritative data retrieved from the authoritative data source 70. Generally, the apparatus 100 may operate transparently to the client devices 50a-50n and/or the downstream process 72. For example, any instructions and/or apps executed by the client devices 50a-50n and/or the downstream process 72 may not necessarily benefit from modification for compatibility with the apparatus 100 (e.g., the compatibility of the apparatus 100 may be inherent based on the architecture of the apparatus 100 and/or how the apparatus 100 interacts with the input/output of the AI engines 60a-60n).

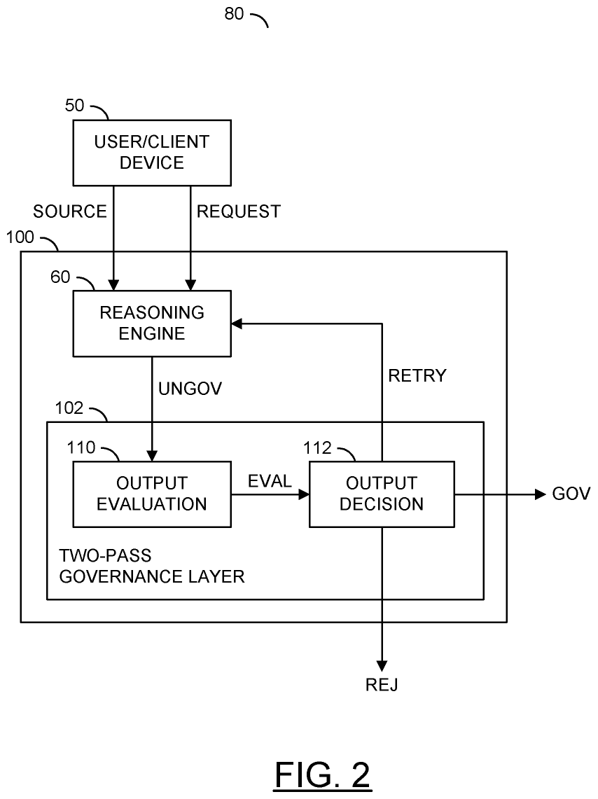

Referring to FIG. 2, a block diagram illustrating a two-pass governance layer is shown. A system 80 is shown. The system 80 may comprise a content generation system. The content generation system 80 may enable an end user to request output from a generative artificial intelligence (AI) engine. The content generation system 80 may generally enable the end user to request output (e.g., generative text, generative audio, generative image(s), etc.) using an input prompt. The type of output provided by the content generation system 80 may be varied according to the design criteria of a particular implementation.

The content generation system 80 may comprise a block (or circuit) 50 and/or the apparatus 100. The circuit 50 may implement a client device. The content generation system 80 may comprise other content (not shown). For example, a networking system may be implemented between the client device 50 and the apparatus 100 (e.g., or the cloud computing service 12) to enable communication over the internet. The number, type and/or arrangement of the content generation system 80 may be varied according to the design criteria of a particular implementation.

The client device 50 may be a representative example of one of the client devices 50a-50n described in association with FIG. 1. The client device 50 may generate the signal REQUEST and/or the signal SOURCE. The signal REQUEST and the signal SOURCE may each be an input for an AI engine. In some embodiments, the signal REQUEST may comprise text input. For example, the text input may comprise a plain language description and/or natural language input (e.g., text that provides similar language to a person may use to communicate to another person). Generally, the text input may not necessarily require a particular format (e.g., may not require boolean formatting, may not require computing code, may not conform to a particular API, etc.). In some embodiments, the signal REQUEST may be text input provided by a person. The signal REQUEST may comprise text that may ask a question and/or instruct the apparatus 100 to generate output in a particular format. For example, the signal REQUEST may comprise a question, a command, instructions, a formatting directive (e.g., a structured output template), a task specification, a prompt, etc. The signal SOURCE may comprise a data source. The signal SOURCE may comprise other types of input. For example, the data provided in the signal SOURCE may comprise computer readable data formats such as a document (e.g., a .txt file, a . doc file, a .pdf file, a .docx file, a .xlx, file, a .odf file, etc.), an audio file (e.g., a .wav file, a .mp3 file, a .flac file, etc.), an image file (e.g., a .jpg, a .png, a .bmp, etc.), a video file (e.g., a .mp4 file, a .mkv file, a .mov file, etc.), etc. The signal SOURCE may comprise parameter values corresponding to at least one predefined semantic role. In some embodiments, the signal REQUEST may comprise text accompanying the computer readable data in the signal SOURCE (e.g., a question and/or instructions about a text file such as asking for a summary, asking for corrections, asking to fill in data, etc.). For example, the data source in the signal SOURCE may be used to analyze and/or respond to the input in the signal REQUEST. The type of data provided in the signal REQUEST and/or the signal SOURCE may be varied according to the design criteria of a particular implementation.

In the example shown, the client device 50 may not receive an input. In some embodiments, the generative AI engine may provide output back to the client device 50. For example, a web interface executed by the client device 50 may enable the end user to provide the input content 20 to the generative AI engine, and the generative AI engine may provide responses to the input (e.g., a conversational interface) that may be provided as output back to the client device 50 (e.g., the output content 22). In some embodiments, the client device 50 may enable the end user to provide the input signal REQUEST and/or the data source signal SOURCE to the generative AI model, and the generative AI model may provide output to downstream devices and/or the downstream process 72 (e.g., the client device 50 may request data such as the latest deals provided by a business, and the generative AI model may communicate the output response to a number of kiosk displays throughout the business). The number, type and/or format of the signals generated by and/or received by the client device 50 may be varied according to the design criteria of a particular implementation.

The apparatus 100 may implement a content pre-filtering system and/or a pre-execution authoritative data binding system. The content pre-filtering system 100 may be configured to operate together with one or more of the AI engines 60a-60n. The content pre-filtering system 100 may be configured to pre-format input to the AI engine and/or filter output generated by the AI engine. For example, the content pre-filtering system 100 may modify and/or guide data to/from the AI engines 60a-60n without directly affecting the model implemented by the AI engines 60a-60n and/or operation of the AI engines 60a-60n.

The content pre-filtering system 100 may be configured to receive the signal REQUEST and/or the signal SOURCE. The content pre-filtering system 100 may be configured to generate the signal GOV and/or a signal (e.g., REJ). The signal GOV may comprise governed output. For example, the governed output may comprise output generated by an AI engine that has been controlled and/or constrained by the content pre-filtering system 100. The signal REJ may comprise rejected output. For example, the rejected output may comprise output generated by the AI engine that has been prohibited by the content pre-filtering system 100. The signal REJ may not necessarily be provided as an output of the content pre-filtering system 100. For example, the rejected output may be used for training data for improving an AI model. The signal GOV may be provided to the downstream process 72. In some embodiments, the signal GOV may be provided to the client device 50. The content pre-filtering system 100 may generate and/or receive other signals (not shown). The number, type and/or format of the signals generated and/or received by the content pre-filtering system 100 may be varied according to the design criteria of a particular implementation.

The content pre-filtering system 100 may comprise a block (or circuit) 60 and/or a block (or circuit) 102. The circuit 60 may implement an AI engine. The AI engine 60 may be a representative example of one or more of the AI engines 60a-60n shown in association with FIG. 1. In the example shown, the AI engine 60 may be a reasoning engine. The circuit 102 may implement a two-pass governance layer. The content pre-filtering system 100 may comprise other components (not shown). The number, type and/or arrangement of the components of the content pre-filtering system 100 may be varied according to the design criteria of a particular implementation.

The AI engine 60 may be configured to receive the signal REQUEST. The AI engine 60 may implement a trained AI model. The AI engine 60 may be configured to generate content in response to the signal REQUEST and/or the signal SOURCE. The AI engine 60 may be configured to generate a signal (e.g., UNGOV). The signal UNGOV may comprise an ungoverned response by the AI engine 60 generated in response to the signal REQUEST and/or the signal SOURCE. The ungoverned response may comprise content generated by the AI engine 60 that may not have constraints (e.g., beyond the operational parameters and/or instructions used for normal operation of the AI engine 60) and may comprise unreliable output (e.g., hallucinations). For example, the signal UNGOV may comprise the response that may be provided as output if the content generation system 80 was implemented without the content pre-filtering system 100.

The AI engine 60 may be configured to produce candidate reasoning content in response to the signal REQUEST and/or a signal SOURCE. The AI engine 60 may receive an input comprising task instructions, contextual information, authoritative parameters retrieved from external data sources, etc. The AI engine 60 may use probabilistic inference to generate candidate content. The candidate content may comprise explanatory text, analytical reasoning, proposed structured outputs associated, etc. associated with a task. The generated content may be provided to downstream analysis modules (e.g., the two-pass governance layer 102 and/or other downstream processes) that may evaluate the ungoverned output.

The AI engine 60 may function as a generative inference component rather than an authoritative data source. The AI engine 60 may generate narrative explanations and/or propose candidate reasoning steps. The AI engine 60 may provide generative capability while the content pre-filtering system 100 may ensure that the resulting output may be consistent with authoritative data sources and/or system policies.

The signal UNGOV generated by the AI engine 60 may comprise candidate output. The candidate output may comprise natural language text, structured data elements, and/or a combination of both natural language and structured data elements. The candidate output may comprise semantic units that may correspond to discrete informational assertions and/or parameter values contained within the generated content. A semantic unit may comprise a phrase, clause, sentence fragment, structured field value, etc. of generated output that may convey a particular factual and/or inferential meaning. The semantic units may be generated in a machine-readable format that may enable the two-pass governance layer 102 to analyze the content of the generated output independently of the AI engine 60. In some embodiments, a semantic unit may be represented as a data structure comprising the extracted textual content together with associated metadata describing attributes of the semantic unit. The metadata may comprise the position of the semantic unit within the generated output, references to source material from which the semantic unit may have been derived, confidence scores generated by the AI engine 60, epistemic classifications identifying whether the semantic unit corresponds to retrieved information or inferred reasoning, etc.

The AI engine 60 may receive a signal (e.g., RETRY). The signal RETRY may be received from the two-pass governance layer 102. The signal RETRY may comprise guidance and/or constraints provided by the two-pass governance layer 102. The signal RETRY may comprise feedback based on the ungoverned response. The signal RETRY may enable the AI engine 60 to generate an updated answer in response to the signal prompt based on the guidance and/or constraints provided by the two-pass governance layer 102. The signal RETRY may enable the AI engine 60 to iteratively generate a more accurate response (e.g., reduce and/or eliminate hallucinations, ensure accuracy, bind output deterministically, etc.). The AI engine 60 may generate and/or receive other signals (not shown). The number, type and/or format of the signals received by and/or generated by the AI engine 60 may be varied according to the design criteria of a particular implementation.

The two-pass governance layer 102 may comprise a block (or circuit) 110 and/or a block (or circuit) 112. The circuit 110 may comprise an output evaluation module. The circuit 112 may comprise an output decision module. The two-pass governance layer 102 may comprise other components (not shown). The number, type and/or arrangement of the components of the two-pass governance layer 102 may be varied according to the design criteria of a particular implementation.

The two-pass governance layer 102 may receive the signal UNGOV. The two-pass governance layer 102 may generate the signal RETRY, the signal GOV and/or the signal REJ. The two-pass governance layer 102 may generate and/or receive other signals (not shown). The number, type and/or format of the data communicated to/from the two-pass governance layer 102 may be varied according to the design criteria of a particular implementation.

The two-pass governance layer 102 may be configured to receive (e.g. intercept) the ungoverned output of the AI engine 60. The two-pass governance layer 102 may be configured to analyze the ungoverned output to determine whether the output of the AI engine 60 may be suitable for the downstream process(es). The two-pass governance layer 102 may be configured to provide feedback to the AI engine 60 (e.g., provide guidance, identify constraints, generate a modified prompt, etc.). The two-pass governance layer 102 may be configured to reject some or all of the ungoverned output of the AI engine 60. The two-pass governance layer 102 may be configured to provide the governed response to the downstream process(es).

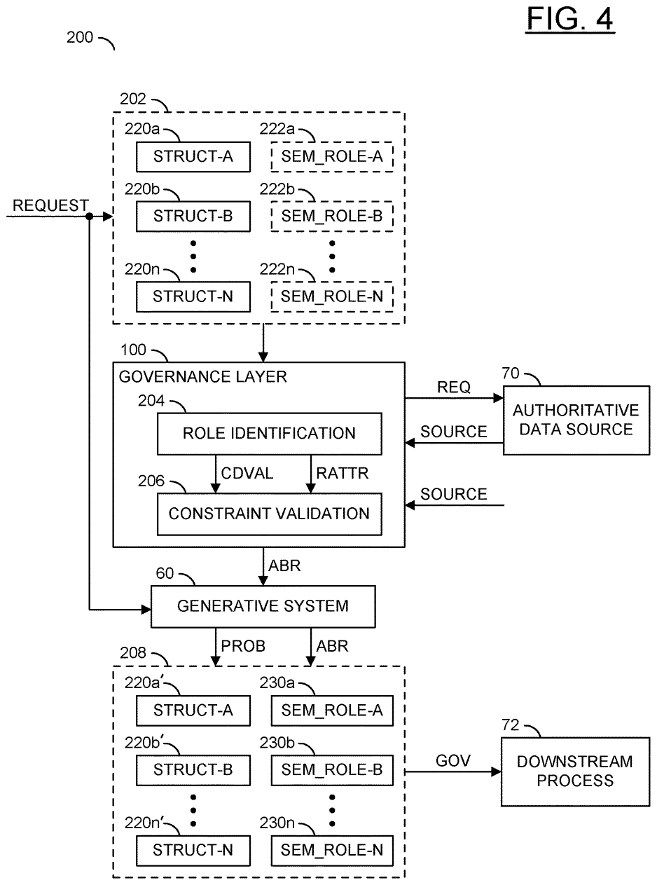

The output evaluation module 110 may be configured to receive the signal UNGOV. The output evaluation module 110 may be configured to evaluate the ungoverned response. For example, the output evaluation module 110 may determine whether the ungoverned response comprises probabilistically inferred content and/or authoritatively determined content. In some embodiments, the output evaluation module 110 may be configured to identify semantic roles and/or perform constraint validation. In some embodiments, the output evaluation module 110 may be configured to analyze semantic units of the ungoverned response and/or provide metadata tags to classify the semantic units. In some embodiments, the output evaluation module 110 may analyze the semantic units according to predefined parameter slots. In some embodiments, the output evaluation module 110 may be configured to determine an amount of divergence from authoritative content and/or calculate a divergence score for the semantic units. Details of the evaluation of the of the ungoverned response may be described in association with FIGS. 4-12.

The two-pass governance layer 102 may operate on semantic units derived from generated content in the signal UNGOV rather than directly analyzing the internal token representations produced by the AI engine 60. Tokens generated by a language model may generally correspond to fragments of text used during probabilistic sequence generation and may not necessarily correspond to complete informational assertions. By contrast, the semantic units may represent higher-level informational elements extracted from the generated output by the output evaluation module 110 that may correspond to discrete factual statements, parameter values, inferential assertions, etc. By operating at the semantic-unit level, the output evaluation module 110 may enable the two-pass governance layer 102 to evaluate the meaning and/or authority of individual assertions within the ungoverned output, which may enable validation, filtering, and/or modification of specific informational elements without requiring access to the internal token-generation mechanisms of the underlying model of the AI engine 60. The semantic units may enable the two-pass governance layer 102 to function with a wide variety of generative models while maintaining consistent control over the informational content of the final output.

The output evaluation module 110 may generate a signal (e.g., EVAL). The signal EVAL may be generated in response to the analysis of the semantic units corresponding to the ungoverned content in the signal UNGOV. The signal EVAL may be presented to the output decision module 112.

The output decision module 112 may be configured to receive the signal EVAL. The output decision module 112 may be configured to generate one or more of the signal RETRY, the signal GOV and/or the signal REJ in response to the signal EVAL. The output decision module 112 may be configured to modify the semantic units to generate governed output. The output decision module 112 may be configured to filter the semantic units to prevent probabilistically inferred content from being provided for content that may be determined by the output evaluation module 110 to require authoritative content.

In some embodiments, the output evaluation module 110 may convert the ungoverned output generated by the AI engine 60 into semantic units. The output evaluation module 110 may enable downstream analysis modules (e.g., the output decision module 112) to evaluate and/or operate on individual informational assertions rather than treating the ungoverned generated output as a monolithic block of text. For example, the output decision module 112 may modify, annotate, filter, and/or replace specific semantic units when validation rules, inference distance thresholds, and/or epistemic classification policies indicate that the ungoverned generated content should be altered prior to final output generation.

The output decision module 112 may control how the generated content of the AI engine 60 may be used. For example, the output evaluation module 110 may analyze the semantic units extracted from the generated output of the AI engine 60 to determine whether particular assertions may be replaced with retrieved values from authoritative sources, filtered according to inference-distance constraints, annotated according to epistemic classification rules, etc. and the output decision module 112 may generate the output based on the analysis of the semantic units. In one example, the signal RETRY may be generated comprising instructions to the AI engine 60 that may indicate which content must use content unmodified from authoritative data source 70. In another example, the signal REJ may comprise rejected content that may not be output to the end user in response to the signal REQUEST and/or the signal SOURCE (e.g., unless requested in the input). For example, the signal REJ may be provided to the downstream process 72 for training purposes. For example, information in the signal REJ may be used as training data for an updated model that may be used by the AI engine 60. In yet another example, the signal GOV may be generated comprising the governed output. The signal GOV may be used by the downstream process indicated in the signal REQUEST. In some embodiments, the signal GOV may be presented as a response to the signal REQUEST to the client device 50 (e.g., to provide the output content 22). The particular combination of the signals generated by the output decision module 112 may be determined based on the information provided in the signal EVAL.

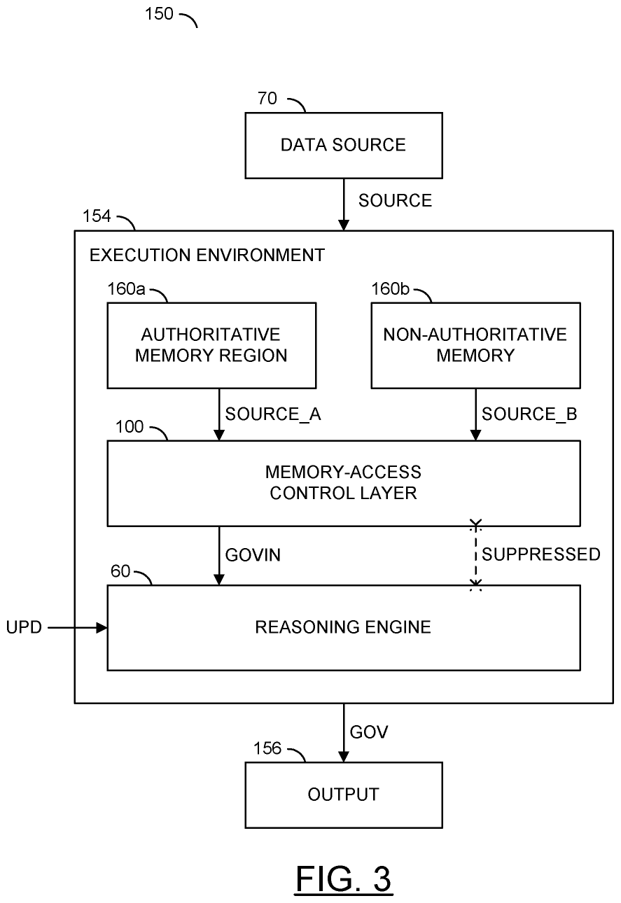

Referring to FIG. 3, a block diagram illustrating architectural input confinement is shown. An input confinement system 150 is shown. The input confinement system 150 may be enabled by the content pre-filtering system 100. For example, instead of operating on the output as shown in association with FIG. 2, in the input confinement system 150, the content pre-filtering system 100 may operate on and/or provide pre-filtering for content provided to the AI engine 60.

The input confinement system 150 may comprise the authoritative data source 70, a block (or circuit) 154, and/or a block (or circuit) 156. The block 154 may implement an execution environment. The block 156 may implement an output. The input confinement system 150 may comprise other components (not shown). The number, type and/or arrangement of the components of the input confinement system 150 may be varied according to the design criteria of a particular implementation.

The input confinement system 150 may provide a representation of the architectural separation between authoritative information and non-authoritative model knowledge within a generative reasoning environment enabled by the content pre-filtering system 100. The authoritative data source 70 may provide the signal SOURCE to the execution environment 154. Generally, the authoritative data source 70 may be external to the execution environment 154. The signal SOURCE may be an input that may be used by the AI engine 60 to provide the output GOV of the execution environment 154. The execution environment 154 may be configured to receive a signal (e.g., UPD). The signal UPD may comprise an update for the AI engine 60. In one example, the update for the AI engine 60 provided by the signal UPD may comprise an updated model (e.g., a version update). In another example, the update for the AI engine 60 provided by the signal UPD may comprise training data. The training data may be used to provide the AI model for the AI engine 60. In some embodiments, the content pre-filtering system 100 may not affect the training of the AI engine 60. For example, the content pre-filtering system 100 may enable the generation of governed output without re-training the AI model implemented by the AI engine 60. The authoritative data source 70 may be a separate data source from a source that may update the AI engine 60. In some embodiments, the content pre-filtering system 100 may generate the signal REJ and/or the signal GOV, as shown in association with FIG. 2, to provide additional content for the training data 152. However, any impact of the output of the content pre-filtering system 100 on the AI model implemented by the AI engine 60 may not be usable until the next time the AI model is updated. For example, in a live operating environment, the output of the content pre-filtering system 100 may not affect how the AI engine 60 works internally. The authoritative data source 70 may comprise a database, a website, an article, a published scientific paper, an archive, etc. Whether the data source is provided by the end user, whether the data source is retrieved from the authoritative data source 70 and/or the types of the authoritative data source 70 may be varied according to the design criteria of a particular implementation.

In some embodiments, the signal SOURCE may be provided by the client device 50 (e.g., as shown in association with FIG. 2). For example, the client device 50 may provide the signal SOURCE comprising a pre-defined data segment. The pre-defined data segment may comprise a selection of text that may be intended by the end user to be reproduced by the AI engine 60 word for word. In one example, the pre-defined data segment may comprise text from a citation (e.g., a legal citation, a citation from an article, a quotation from a speaker, an MLA citation, etc.).

In some embodiments, the signal SOURCE may be data stored in a closed system. For example, the authoritative data source 70 may comprise storage for a closed system. In one example, the closed system may be a repository for medical records. In another example, the closed system may be a repository for police evidence. In yet another example, the closed system may be government records. Generally, for the authoritative data source 70 implemented as a closed system, the authoritative data source 70 may have limited access (e.g., no external access from outside the closed system, accessible externally only using an API, accessible using pre-defined credentials, etc.). The content pre-filtering system 100 may maintain a designation record identifying the authoritative data source 70 for the closed system as being an authoritative source for predefined semantic roles (e.g., data retrieved from the authoritative data source 70 may be deemed authoritative and/or may be stored in a fixed buffer). The content pre-filtering system 100 may be configured to prevent probabilistic substitution by the AI engine 60 for the authoritative data. In some embodiments, the content pre-filtering system 100 may prevent execution by the AI engine 60 when the authoritative data source 70 is not accessible (e.g., the data source cannot be retrieved from the closed system).

In some embodiments, the authoritative data source 70 may be a third party data source (e.g., a website, a library archive, a newspaper archive, a digital encyclopedia, etc.). In one example, the authoritative data source 70 may be specifically identified by the client device 50 with the signal REQUEST (e.g., requesting professional athletic statistics from espn.com). In another example, the authoritative data source 70 may be a government resource (e.g., a website that provides up-to-date government rules, laws, regulations, building codes, etc.). In some embodiments, the content pre-filtering system 100 may be configured to determine and/or store a trust level ranking for the authoritative data source 70 (e.g., multiple websites may be accessible for accessing data, each with varying levels of reliability). For example, the trust level may be used to determine which website to access as the authoritative data source 70. In some embodiments, the content pre-filtering system 100 may be configured to generate a question comprising a list of available resources for the end user. The end user may select the desired resource from the list provided in the question, and the content pre-filtering system 100 may use the selection as the authoritative data source 70 (e.g., in a request for hockey statistics, the content pre-filtering system 100 may provide a question listing nhl.com, tsn.ca, and espn.com as available options). The particular method of determining the data source may depend on the available access to external systems, the information provided in the request, the available third party sources, etc. and may be varied according to the design criteria of a particular implementation.

The execution environment 154 may be configured to execute computer readable systems, store data, access external data sources, etc. In some embodiments, the execution environment 154 may be implemented using at least a processor and/or a memory. Other computing components may be used to enable the execution environment 154 (e.g., hardware accelerators such as graphics processing units (GPUs), accelerated processing units (APUs), neural processing units (NPUs), etc.). The execution environment 154 may be implemented on a personal computing device (e.g., a desktop computer, a laptop computer, smartphone, etc.), on an AI box (e.g., a computing device comprising hardware selected for performing AI-related operations), a computing service (e.g., a server, the cloud computing service 12, a mainframe, etc.), etc. The particular hardware and/or combinations of hardware that may implement the execution environment 154 may be varied according to the design criteria of a particular implementation.

The execution environment 154 may comprise a blocks (or circuits) 160a-160b, the AI engine 60 and/or the content pre-filtering system 100. The circuit 160a may implement an authoritative memory region. The circuit 160b may implement a non-authoritative memory region. The execution environment 154 may comprise other components (not shown). The number, type and/or arrangement of the components of the execution environment 154 may be varied according to the design criteria of a particular implementation.

The authoritative memory region 160a and the non-authoritative memory region 160b may each be memory regions accessible by the content pre-filtering system 100 and/or the AI engine 60. A memory space of the execution environment 154 may be divided into the authoritative memory region 160a and the non-authoritative memory region 160b. The authoritative memory region 160a may comprise data storage of data sources that comprise authoritative data. The authoritative data may comprise data sources that may be confirmed as trustworthy, previously validated and/or reliable. In one example, the authoritative memory region 160a may be implemented as a fixed buffer (e.g., memory space not writable to by the AI engine 60). The non-authoritative memory region 160b may comprise data sources that comprise non-authoritative data. The non-authoritative data may comprise data sources that may be unreliable, unconfirmed, not previously validated and/or continually evolving. The non-authoritative data comprise training-derived model knowledge and/or other probabilistic information sources. In the example shown, the authoritative data and the non-authoritative data are shown as stored in memory. In some embodiments, the authoritative memory region 160a and/or the non-authoritative memory region 160b may comprise data retrieved from external sources. In some embodiments, whether data sources may be considered to be authoritative or non-authoritative may be determined according to third-party validation, according to a list of pre-defined trusted sources, and/or authorization by the end user. In some embodiments, the authoritative memory region 160a may comprise data provided by the signal SOURCE. The particular method of distinguishing the authoritative data from the non-authoritative data may be varied according to the design criteria of a particular implementation.

The content pre-filtering system 100 may be configured to receive a signal (e.g., SOURCE_A) and/or a signal (e.g., SOURCE_B). The signal SOURCE_A may comprise authoritative data provided by the authoritative memory region 160a. The signal SOURCE_B may comprise non-authoritative data provided by the non-authoritative memory region 160b. The content pre-filtering system 100 may be configured to generate a signal (e.g., GOVIN). The signal GOVIN may comprise governed input. The signal GOVIN may be presented to the AI engine 60. The content pre-filtering system 100 may generate and/or receive other signals (not shown). The number, data and/or format of the signals communicated to/from the content pre-filtering system 100 may be varied according to the design criteria of a particular implementation.

The content pre-filtering system 100 may be configured to operate as a memory-access control layer to govern how the AI engine 60 may access and/or use information from the authoritative memory region 160a and/or the non-authoritative memory region 160b. In one example, particular semantic roles and/or parameters may be restricted to values obtained only from the authoritative memory region 160a. For example, if the AI engine 60 attempts to generate and/or propagate values derived solely from the non-authoritative memory region 160b in contexts requiring authoritative resolution, the output (e.g., the signal SOURCE_B) may be suppressed and/or prevented from propagating to downstream systems by the content pre-filtering system 100.

In the example shown, the signal SOURCE_A may be passed through to the AI engine 60 by the content pre-filtering system 100 as the signal GOVIN and the signal SOURCE_B may be suppressed by the content pre-filtering system 100 (e.g., prevented from being accessed by the AI engine 60). In some embodiments, the signal SOURCE_B may be enabled and/or passed through along with the signal SOURCE_A in the signal GOVIN. The content pre-filtering system 100 may determine the amount and/or in which contexts that probabilistic determined information from the non-authoritative memory region 160b may be enabled for use by the AI engine 60. For example, in some contexts (e.g., medical dosing, reciting sports statistics, quoting a news article, quoting a document, etc.), the signal SOURCE_B may be completely suppressed (e.g., to prevent misquoting, to prevent providing potentially false and/or hallucinated information, to follow instructions precisely, etc.). In another example, in some contexts (e.g., providing a narrative overview, providing a basic summary, translations, etc.) some or all of the signal SOURCE_B may be enabled. The content pre-filtering system 100 may determine the context and/or evaluate an amount of divergence from the authoritative source may be allowable.

In some embodiments, the content pre-filtering system 100 may be configured to receive an input comprising a request from an end user that may be associated with a structured output comprising one or more predefined semantic roles from a data source (e.g., the signal SOURCE_A and/or the signal SOURCE_B). The content pre-filtering system 100 may be configured to identify at least one of the predefined semantic roles as an authoritatively bound role prior to execution of the generative machine learning system (e.g., the AI engine 60). The content pre-filtering system 100 may be configured to retrieve a candidate value corresponding to the authoritatively bound role from the authoritative memory region 160a. The content pre-filtering system 100 may be configured to evaluate whether the candidate value satisfies a validation constraint and populate the authoritatively bound role with the candidate value in response to the candidate value satisfying the validation constraint. The content pre-filtering system 100 may generate an input context (e.g., the signal GOVIN) comprising the populated authoritatively bound role for the AI engine 60. The content pre-filtering system 100 may enable the AI engine 60 to generate remaining portions of the structured output while maintaining the populated authoritatively bound role as fixed.

The content pre-filtering system 100 may retrieve candidate values from an authoritative source first, and then the AI engine 60 may generate probabilistically inferred content (e.g., reasoning, narrative, surrounding content, etc.). The semantic roles may be already filled to prevent the AI engine 60 from hallucinating content for the semantic roles (e.g., the probabilistic reasoning may operate around and/or complement the authoritatively determined parameters).

Referring to FIG. 4, a block diagram illustrating deterministic role enforcement is shown. A system 200 is shown. The system 200 may implement a role enforcement system. The role enforcement system 200 may be configured to control a population of required semantic roles in a generative machine learning output.

The role enforcement system 200 may comprise the AI engine 60, the authoritative data source 70, the downstream process 72, a structured output template 202, the content pre-filtering system 100 comprising a block (or circuit) 204 and/or a block (or circuit) 206, and/or a structured output 208. The circuit 204 may implement a role identification module. The circuit 206 may implement a constraint validation module. The role enforcement system 200 may comprise other components (not shown). The number, type and/or arrangement of the components of the role enforcement system 200 may be varied according to the design criteria of a particular implementation.

The role enforcement system 200 may receive the signal REQUEST and/or the signal

SOURCE. For example, the signal REQUEST may be received from the client device 50. The signal REQUEST may be presented to the AI engine 60 and the content pre-filtering system 100. The signal SOURCE may be presented to the content pre-filtering system 100. In some embodiments, the signal SOURCE may be provided by the client device 50. In some embodiments, the content pre-filtering system 100 may receive the signal SOURCE from the authoritative data source 70 (e.g., in response to the signal REQ). Whether the signal SOURCE is provided by the client device 50, the authoritative data source 70 and/or another source may be varied according to the design criteria of a particular implementation.

The signal REQUEST may comprise the structured output template 202. The structured output template 202 may be a format and/or template for the output. For example, the end user may ask the AI engine 60 to provide output in a particular format along with asking for information and/or data. The structured output template 202 may be provided to guide the AI engine 60 to provide output into a desired format.

The structured output template 202 may comprise components 220a-220n and/or 222a-222n. The components 220a-220n may comprise structural components. The components 222a-222n may comprise semantic roles. The structural components 220a-220n may comprise a portion of the structured output template 202 that may provide support for the semantic roles 222a-222n. The semantic roles 222a-222n may comprise parameters that may be filled in. The structural components 220a-220n and/or the semantic roles 222a-222n may be generated by the AI engine 60.

Generally, the structural components 220a-220n may be content that may be populated by probabilistically generated content from the AI engine 60 (e.g., analytical and/or explanatory functions). The role enforcement system 200 may restrict one or more of the semantic roles 222a-222n from being populated by the probabilistically generated content. For example, in response to a question provided by the signal REQUEST, for the structural components 220a-220n, the AI engine 60 may generate an answer, but for some of the semantic roles 222a-222n (e.g., semantic roles identified as an authoritatively bound role), the AI engine 60 may generate an answer that may be locked to verified data from the content pre-filtering system 100.

In one example, for the structured output template 202 that provides medical information, the structural components 220a-220n may comprise headings and/or additional information and the associated semantic roles 222a-222n may comprise values (e.g., the structural component 220a may comprise “the patient has a weight of:” while the associated semantic role 222a may comprise “200 lbs”). In another example, for the structured output template 202 that provides sports statistics, the structural components 220a-220n may comprise headings and/or additional information and the associated semantic roles 222a-222n may comprise statistical values (e.g., the structural component 220a may comprise “the leading scorer in the NHL had:” and the structural component 220b may comprise “the best goalie in the NHL had:” while the associated semantic role 222a may comprise “50 goals” and the associated semantic role 222b may comprise “2.19 GAA”). In yet another example, for a financial transaction recommendation generated by a particular person, the structural components 220a-220n may comprise various justifications for making or not making a purchase, and the semantic roles 222a-222n may comprise particular investments and/or current values of the investments. The particular type of structural components 220a-220n and/or the semantic roles 222a-222n may be varied according to the design criteria of a particular implementation.

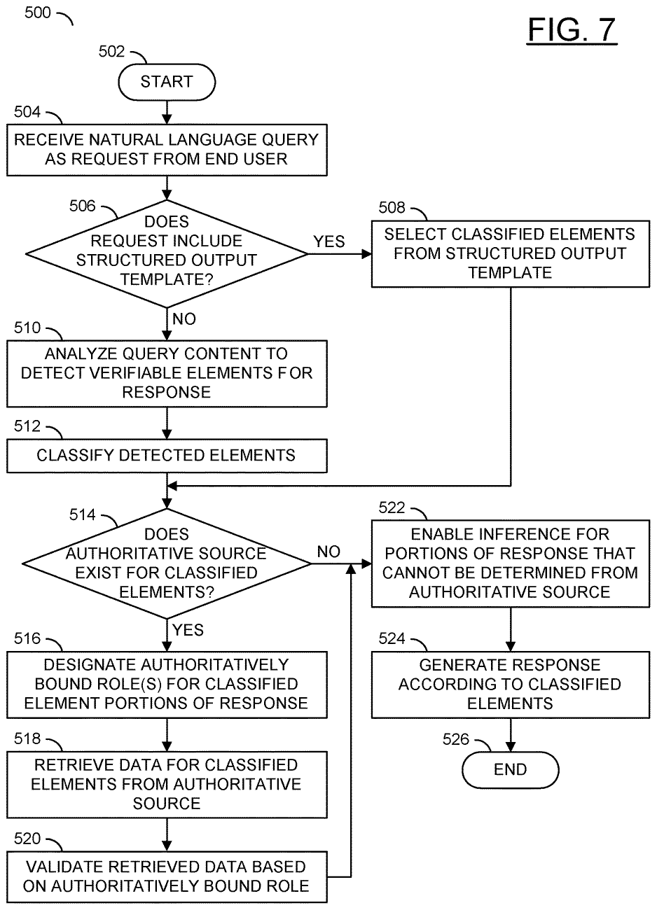

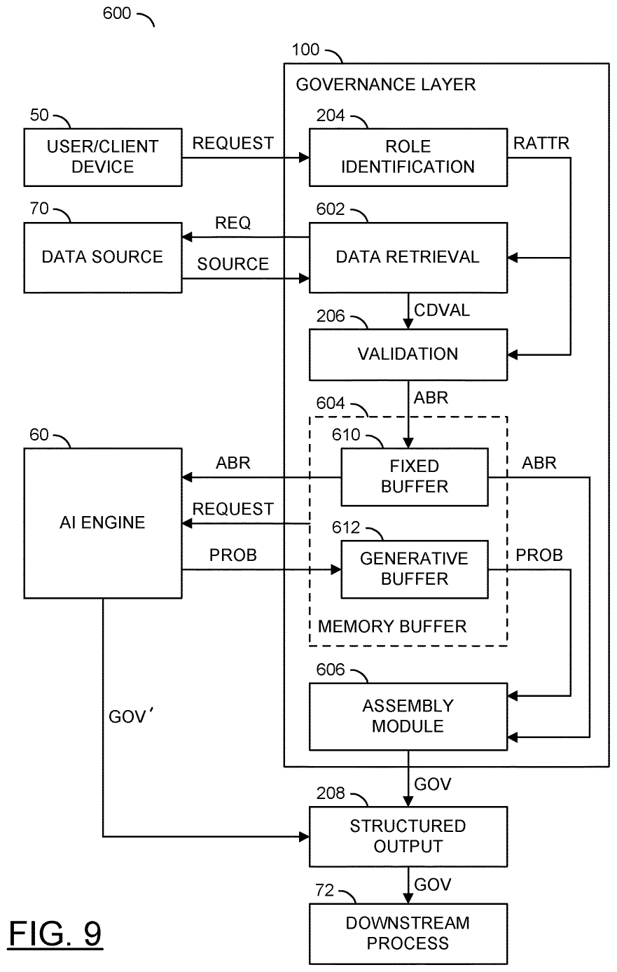

The content pre-filtering system 100 may be configured to analyze the information in the signal REQUEST. In some embodiments, the signal SOURCE may be provided by the client device 50 with the signal REQUEST. In some embodiments, the content pre-filtering system 100 may comprise one or more components configured to analyze the input to determine whether to access the authoritative data source 70. To retrieve information from the authoritative data source 70, the content pre-filtering system 100 may generate the signal REQ. The authoritative data source 70 may provide the signal SOURCE in response to the signal REQ. Details for determining whether to access the authoritative data source 70 may be described in association with FIG. 7 and/or FIG. 9.

The role identification module 204 may be one component of the content pre-filtering system 100 (e.g., the input governance layer). The role identification module 204 may be configured to receive and/or parse the signal REQUEST. The role identification module 204 may be configured to determine which content in the structured output template 202 may be the structural components 220a-220n and/or the semantic roles 222a-222n. The role identification module 204 may be configured to determine which of the semantic roles 222a-222n may be classified as an authoritatively bound role. For example, some of the semantic roles 222a-222n may be required to be filled in with particular data types, but may be filled in with general values and/or values that may not necessarily need to be precise, while some of the semantic roles 222a-222n may be required to be filled in with particular data types, but may be required to be precise content from a data source. In an example, one of the semantic roles 222a-222n may be a weight value that may be required to be provided in units of pounds, but providing an exact and/or precise value may not be beneficial (e.g., approximately 200 lbs may be acceptable, even if a person actually weighs 198 lbs). In another example, one of the semantic roles 222 a-222n may be known allergies of a patient, which must be cited accurately from a data source.

In some embodiments, the structured output template 202 may comprise an indication of which of the content in the structured output template 202 may be the semantic roles 222a-222n and/or which of the semantic roles 222a-222n may be an authoritatively bound role. For example, the signal REQUEST may ask in plain language that the AI engine 60 (e.g., the content pre-filtering system 100 may be transparent to the end user) provide a general description of a patient and list the known allergies of the patient, and may indicate that the patient name and the allergies be cited precisely from the medical record. In response to the signal REQUEST, the role identification module 204 may identify that the end user requested that the name and the allergies may be the semantic roles 222a-222n that may be authoritatively bound, while the general description of the patient may be the structural components 220a-220n (e.g., the structural components 220a-220n may describe that the patient appears to be generally fit, while the semantic roles 222a-222n cite from the medical record that the patient is named John Smith and has an allergy to penicillin). In some embodiments, the role identification module 204 may be configured to analyze the structured output template 202 to determine which content may be structural components 220a-220n and which content may be semantic roles 222a-222n. For example, the role identification module 204 may store particular data types that may be known to be semantic roles 222a-222n and/or authoritatively bound roles. In one example, for a NHL player, the authoritatively bound roles may be stored as a lookup table comprising, goals, assists, points, penalty minutes, games played, shots, faceoff wins, time on ice, powerplay goals, shorthanded goals, game winning goals, etc.

In some embodiments, the role identification module 204 may be configured to define role attributes for the authoritatively bound roles. The role attributes may be determined in response to the context of the semantic roles 222a-222n. The role attributes may indicate particular categories for the authoritatively bound roles. For example, some of the authoritatively bound roles may comprise data that may rarely change, data that may be continually evolving and/or conditional data. For example, for statistical data for an athlete, data from completed seasons may not change. In another example, a currency exchange rate may evolve regularly. The particular types of the role attributes identified for the semantic roles 222a-222n and/or the authoritatively bound roles by the role identification module 204 may be varied according to the design criteria of a particular implementation.

The role identification module 204 may be configured to generate a signal (e.g., CDVAL) and/or a signal (e.g., RATTR). The signal CDVAL may comprise candidate values. The signal RATTR may comprise the authoritatively bound roles and/or the role attributes for the authoritatively bound roles. The signal CDVAL and/or the signal RATTR may be presented to the AI engine 60 and/or the constraint validation module 206. For example, constraint validation may be an optional feature provided by the content pre-filtering system 100. The signal CDVAL and/or the signal RATTR may be generated by the role identification module 204 in response to the structured output template 202 provided in the signal REQUEST and/or the signal SOURCE.

The role identification module 204 may be configured to identify lifecycle behavior for the parameters used in generative reasoning systems. For example, for the semantic roles 222a-222n, the role identification module 204 may determine attributes for the authoritatively bound roles. The role attributes (e.g., provided in the signal RATTR) may provide practical limitations for the semantic roles 222a-222n. For example, some roles may represent stable attributes that rarely change, others may represent parameters that must be retrieved in real time to ensure currency, and still others may become relevant only when certain contextual conditions are present. In an example, in pediatrics, weight-based dosing may be used unless the patient is morbidly obese. When a patient is morbidly obese, dosing may be determined according to lean body weight to prevent overdose. The lean body weight may be a conditional role attribute (e.g., conditional upon obesity), while the weight may be a dynamic role attribute (e.g., required to be current). In another example, a static role attribute may be an archived value, such as statistics for an athlete from seasons that have been completed, while the dynamic role attribute may be a current value such as a particular statistic for the athlete from the current (e.g., ongoing) season. In yet another example, dynamic role attributes may be used for patient allergies and/or current medications. The role identification module 204 may not only classify the semantic roles 222a-222n according to the authoritative data source but also according to lifecycle role attributes governing when and how those roles must be resolved.

In some scenarios, the signal CDVAL may be suitable output for the structured output template 202. In some scenarios, the signal CDVAL may be unsuitable for the structured output template 202. The signal CDVAL may provide a candidate value for validation and the signal RATTR may provide information about the authoritatively bound role as a basis for validation. The signal CDVAL and/or the signal RATTR may be presented to the constraint validation module 206.

The constraint validation module 206 may be a component of the content pre-filtering system 100. The constraint validation module 206 may be configured to receive the signal CDVAL and/or the signal RATTR. The constraint validation module 206 may be configured to evaluate whether the candidate values in the signal CDVAL may satisfy one or more validation constraints. The validation constraints may be pre-defined parameters and/or parameters determined according to the semantic roles 222a-222n and/or the authoritatively bound role(s). For example, one or more of the validation constraints may be determined in response to the signal CDVAL and/or the signal RATTR. The validation constraints may ensure that candidate values may be acceptable for the semantic roles 222a-222n and/or the authoritatively bound roles. The validation constraints may prevent the AI engine 60 from filling the content for the semantic roles 222a-222n identified as the authoritatively bound roles using content that may have been probabilistically generated. The validation constraints may override probabilistic inference. The validation constraints may enforce completion conditions for the structured output template 202. In some embodiments, the constraint conditions may be defined by the authoritatively bound roles data and/or the role attributes provided by the role identification module 204. The particular constraint conditions may be varied according to the design criteria of a particular implementation.

The validation constraints that may be applied to an authoritatively bound role may not necessarily be fixed and may vary depending on the particular semantic roles 222a-222n being populated and/or the characteristics of the associated authoritative data source. In some embodiments, the constraint validation module 206 may associate different validation rules with different types of semantic roles in order to ensure that the retrieved parameter value for the candidate values may be suitable for use in the generated output. In one example, validation constraints for a numerical parameter may comprise range checks and/or plausibility verification. In another example, validation constraints for temporal data may comprise a confirmation that the retrieved value is current.

In some embodiments, the validation constraints may verify that the retrieved content matches an authoritative record, satisfies a defined format, corresponds to a recognized identifier, etc. The validation process may be role-specific and/or may be selected dynamically based on the semantic role and the authoritative data source from which the candidate value is retrieved. For example, the particular validation constraints may depend on the semantic roles 222a-222n and the data source (e.g., determined from the signal CDVAL and/or the signal RATTR). While some of the validation constraints may overlap for each of the authoritatively bound roles, generally each of the authoritatively bound roles may have individual and/or distinct validation constraints that may be appropriate for the type of parameter being enforced. The specific validation constraints applied to a given role may depend on the nature of the parameter, the characteristics of the authoritative data source, the requirements of the downstream process 72, etc. In one example, for a medical system, a patient weight parameter may be validated by confirming that the value falls within physiologically plausible limits and corresponds to a recent chart entry. In another example, for a player statistic retrieved from a sports database, the parameter may be validated by confirming that the value corresponds to an official league record. In yet another example, for a financial transaction, parameters such as account balances may be validated to ensure that the retrieved value reflects the most recent transaction state. The validation constraints may comprise format and/or structural checks. For example, for a legal citation, the parameter may be validated by confirming that the retrieved text matches the official language stored in a legal database. The particular validation constraints for each type of the semantic roles 222a-222n and/or the authoritatively bound role(s) may be varied according to the design criteria of a particular implementation.

The content pre-filtering system 100 may generate a signal (e.g., ABR). In some embodiments, the signal ABR may be generated by the content pre-filtering system 100 without performing constraint validation. In some embodiments, the constraint validation module 206 may generate the signal ABR after performing the constraint validation. The signal ABR may comprise populated authoritatively bound content and/or valid output (e.g., governed output). In some embodiments, the signal ABR may be generated in response to the signal REQUEST and the signal SOURCE. For example, when the content pre-filtering system 100 is implemented without the constraint validation module 206, the signal ABR may comprise the candidate values retrieved from the authoritative data source 70. In some embodiments, the signal ABR may be generated by the constraint validation module 206 in response to evaluating the candidate values in the signal CDVAL and/or the role attributes in the signal RATTR. The signal ABR may be presented to the AI engine 60. The signal ABR may comprise the authoritatively bound role(s) that have been populated with values by the content pre-filtering system 100.

In some embodiments, the constraint validation module 206 may block output to the AI engine 60. In one example, when constraint validation fails, the signal ABR may not be presented to the AI engine 60. For example, since the authoritatively bound role cannot be satisfied due to the validation failure, the content pre-filtering system 100 may prevent the AI engine 60 from generating output (e.g., for some scenarios, no output may be better than the AI engine 60 hallucinating output). In one example, for a closed system for a medical system portal that receives medical prescription information, if the medical record cannot be accessed and/or required information is missing from the medical record, then no prescription may be generated. In some embodiments, the constraint validation module 206 may enable the content pre-filtering system 100 to attempt to retrieve more accurate data from the authoritative data source 70 (or attempt a different data resource). For example, for a request about athletic statistics, if the one resource is unavailable or is lacking information from the current season, the constraint validation module 206 may generate a request from another resources (e.g., nhl.com may be unavailable, but espn. com may be used as an alternate to receive another set of candidate values for the authoritatively bound role).

The signal ABR may be presented to the AI engine 60 along with the signal REQUEST. The content pre-filtering system 100 may provide the signal ABR comprising the populated authoritatively bound role(s) to the AI engine 60 (e.g., a generative machine learning system) as part of an execution context for generating the structured output 208. The signal ABR may provide read-only data for the semantic roles 222a-222n. The AI engine 60 may be configured to generate the signal ABR and/or a signal (e.g., PROB) in response to the signal ABR and the signal REQUEST. The signal PROB may comprise probabilistically inferred content generated by the AI engine 60. The signal PROB may comprise similar content as the signal UNGOV described in association with FIG. 2.

The signal PROB may comprise probabilistic inferences generated by the AI engine 60 for the structural components 220a-220n and/or the semantic roles 222a-222n. In one example, the signal ABR may be passed through by the AI engine 60 to fill the semantic roles 222a-222n that are authoritatively bound and the signal PROB may comprise inferred content that may be used to generate remaining content to fill the structured output template 202. In another example, the signal ABR may be used as read-only content (e.g., a deterministic parameter) that the AI engine 60 may build a response around (e.g., make inferences based on the fixed data for the authoritatively bound role). In one example, for a request asking about the best athlete of all time, the statistics (e.g., goals, points, number of championships won, number of individual awards won, etc.) may be authoritatively bound data, while the subjective portion may be probabilistically inferred by interpreting the statistics (e.g., most points or most individual awards may provide a basis for deciding which player is best, but who is best may still be debatable). The AI engine 60 may be permitted to infer values for the semantic roles 222a-222n other than the authoritatively bound roles. In one example, the AI engine 60 may generate narrative content (e.g., the structural components 220a-220n) that references the authoritatively bound role(s) and the content pre-filtering system 100 may prevent modification of the authoritatively bound roles that have been populated. The amount of content that may be probabilistically inferred and provided as output along with the populated authoritatively bound role(s) may be varied according to the design criteria of a particular implementation.

The signal REQUEST may provide the input that the AI engine 60 may use to generate output. For example, the signal REQUEST may ask the AI engine 60 to analyze a document (e.g., a text file such as a medical record), and the end user may provide the document as the signal SOURCE. In another example, the signal SOURCE may be received from the authoritative data source 70 by the content pre-filtering system 100. In one example, the signal REQUEST may ask the AI engine 60 to search a medical record for a patient, and the content pre-filtering system 100 may request the medical record from the authoritative data source 70 to provide the populated authoritatively bound roles. In another example, the signal REQUEST may ask the AI engine 60 to find the top 10 goalies according to save percentage from the website nhl.com and the content pre-filtering system 100 may request data from the website to provide the populated authoritatively bound roles to the AI engine 60.

The structured output 208 may be provided by the signal GOV. The structured output 208 may be populated with content generated by the AI engine 60 in response to the signal REQUEST and/or the signal ABR. The structured output 208 may comprise filled structural components 220a′-220n′ and/or validated semantic roles 230a-230n. The filled structural components 220a′-220n′ may be generated comprising the probabilistically generated content. The filled structural components 220a′-220n′ may be filled in by the AI engine 60 based on and/or using the values provided in the signal ABR to provide narrative context. The validated semantic roles 230a-230n may be filled in by the AI engine 60 using the probabilistically generated content and/or the authoritative content that may have been validated by the constraint validation module 206 depending on which of the validated semantic roles 230a-230n have been identified as the authoritatively bound roles. The structured output 208 may comprise a combination of one or more populated authoritatively bound roles and probabilistically generated content produced by the AI engine 60.

The downstream process 72 may be configured to receive the signal GOV. The signal GOV may comprise the structured output 208 generated by the AI engine 60 (e.g., a combination of the populated authoritatively bound roles in the signal ABR and the probabilistically inferred content in the signal PROB). The downstream process 72 may provide one or more processes and/or actions in response to the structured output 208.

The authoritatively bound role (e.g., a deterministically bound role) may be content that may be an output provided by a canonical source. The role enforcement system 200 may ensure that the authoritatively bound role comprises output that may be determined according to an authority of values. The role enforcement system 200 may not necessarily determine how the AI engine 60 generates probabilistically inferred content. The role enforcement system 200 may ensure that particular fields of the structured output 208 come from the authoritative data source, regardless of what the AI engine 60 might otherwise generate. The validated semantic roles 230a-230n that correspond to the authoritatively bound roles identified by the role identification module 204 in response to an analysis of the semantic roles 222a-222n may be supplied deterministically from the data source rather than inferred probabilistically by the AI engine 60. The filled structural components 220a′-220n′ may be narrative and/or reasoning content that may be generate probabilistically by the AI engine 60. The validated semantic roles 230a-230n may comprise output that may be values that must come from a verified data source. The authoritatively bound data roles may be bound to authoritative data and not to the generative process implemented by the AI engine 60. The role identification module 204 and/or the constraint validation module 206 may enforce data output binding that may prevent the AI engine 60 from inventing (e.g., hallucinating) a value.

The authoritatively bound roles may be one or more of the semantic roles 222a-222n that may be supplied values that must be retrieved from an authoritative data source, must satisfy validation rules and cannot be populated by probabilistic generation. The authoritatively bound roles may be satisfied when the output is bound to an authoritative data source or has a value deterministically retrieved from a data source. The role identification module 204 may identify an authoritatively bound role among the one or more predefined semantic roles 222a-222n. The content pre-filtering system 100 may retrieve a parameter value associated with the authoritatively bound role. The constraint validation module 206 may prevent probabilistically generated content from populating the authoritatively bound role. The role identification module 204 and the constraint validation module 206 may ensure that the authoritatively bound role may be a semantic role with a value that must be supplied from an authoritative data source rather than through probabilistic generation by the AI engine 60.

The role enforcement system 200 may implement a governance layer that may enforce rules before an AI system is allowed to produce or use an answer. The AI engine 60 may be a system such as a LLM that generates text and/or answers (e.g., ChatGPT, Claude, Gemini, a hospital AI assistant, an automated legal drafting tool, etc.). The input may comprise a request such as “generate a prescription for patient X”, or “draft a treatment plan for patient X”. The structured output template 202 may comprise an output that may comprise specific fields and/or slots, rather than purely free text. For example, the semantic roles 222a-222n for the structured output template 202 may comprise a drug, a dosage, a patient weight, blood pressure, a surgery date, a contact name, etc. The authoritatively bound roles may be the semantic roles 222a-222n that must come from verified data (e.g., without the AI engine 60 “guessing”). For example, dosing may be an authoritatively bound role that may come from dosing rules. The candidate values may comprise retrieved values for the semantic roles 222a-222n. For example, the candidate values may comprise ‘Patient weight=82 kg’, ‘Creatinine level=1.3’, ‘Blood pressure=140/90’, etc. The authoritative data source may be a trusted database and/or record that the role enforcement system 200 may treat as ground truth. The authoritative data source may be provided as the signal SOURCE. In an example, the authoritative data source may be one or more of an electronic medical record (EMR), a hospital lab system, a financial database, legal document repository, a government registry, etc. The validation constraints may be rules that may be used to confirm that the candidate values are acceptable. For example, the validation constraints may be associated with data freshness (e.g., lab results from with the last 24 hours), completeness (e.g., a dosage value may not be missing), consistency (e.g., weight and dosage must be consistent with dosing rules, etc.), etc. Probabilistically generated content may be content that the AI engine 60 may be most likely to use to predict an answer. For example, if the medical record does not have a patient weight listed, the AI engine 60 may use an average adult weight. The role enforcement system 200 may forbid the AI engine 60 from using inferred content for the authoritatively bound roles. The constraint validation module 206 may forbid the AI engine 60 from proceeding until the roles are filled correctly (e.g., the prescription may not be filled until the patient allergies are verified). The role enforcement system 200 may force the AI engine 60 to fill particular critical fields using verified data instead of guessing, and may prevent the system from executing anything until the particular fields are validated.

The role enforcement system 200 may pre-declare the required semantic roles semantic roles 222a-222n for the structured output template 202 that the AI engine 60 may fill in (e.g., weight, dosage, contract party, account number, etc.). The role enforcement system 200 may bind the semantic roles 222a-222n to authoritative sources and the AI engine 60 may retrieve values from the authoritative data source 70 (e.g., (databases, records, supplied documents, other verified systems, etc.). The role enforcement system 200 may override probabilistic content generation by the AI engine 60. For example, if a valid value cannot be retrieved and/or validated the role enforcement system 200 may prevent action by the downstream process 72. The role enforcement system 200 may be used for medical orders, financial transactions, legal filings, compliance systems, automated document generation, autonomous agent workflows, etc.

In one example, a hospital may use an AI assistant with the role enforcement system 200 to generate prescriptions. The doctor may provide the input (e.g., the signal REQUEST) with a prompt of “generate an order for Vancomycin for this patient”. The signal REQUEST may further comprise the structured output template 202 (or the structured output template 202 may be previously stored) that provides semantic roles 222a-222n that may be comprise “Drug:”, “Dose:”, “Patient weight:”, “Frequency:”, “Allergies:”, etc. The semantic roles 222a-222n may be filled in by the AI engine 60. The role identification module 204 may identify which of the semantic roles 222a-222n may not be guessed. For example, the allergies and/or the patient weight may not be guessed (e.g., dosing depends on the patient weight and allergies). The AI engine 60 may access the authoritative data source 70 comprising a medical record and retrieve the patient weight (e.g., 82 kg), allergies and/or other information. The constraint validation module 206 may review candidate values generated by the AI engine 60 to check the validation constraints. For example, the constraint validation module 206 may check whether the weight has been recorded in last 24 hours, whether recent allergies have been listed, whether other medications are being taken, whether the units are valid, etc. If the validation is accepted, the values may be used. For example, the downstream process 72 may generate a prescription comprising “Drug: Vancomycin, Weight: 82 kg, Dose: 1250 mg, etc. The role enforcement system 200 may prevent the downstream process 72 from receiving an incomplete data set such as a missing weight, missing allergies, etc. The role enforcement system 200 may prevent a typical adult weight (e.g., probabilistically inferred by the AI engine 60) from being provided instead of the actual weight. The constraint validation module 206 may stop the prescription, insert a placeholder, request a new measurement, escalate the scenario to a doctor, etc.

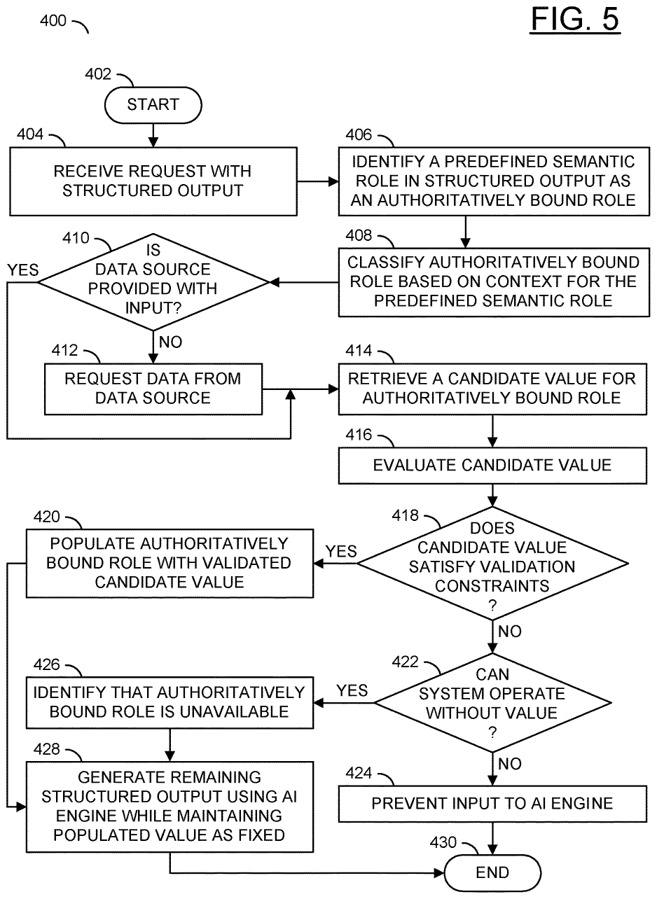

Referring to FIG. 5, a method (or process) 400 is shown. The method 400 may govern input to enable a generative AI engine to populate a structured output with validated content that is bound to an authoritative source. The method 400 generally comprises a step (or state) 402, a step (or state) 404, a step (or state) 406, a step (or state) 408, a decision step (or state) 410, a step (or state) 412, a step (or state) 414, a step (or state) 416, a decision step (or state) 418, a step (or state) 420, a decision step (or state) 422, a step (or state) 424, a step (or state) 426, a step (or state) 428, and a step (or state) 430.

The step 402 may start the method 400. The method 400 may be configured to identify the semantic roles 222a-222n of the structured output template 202. In the step 404, the content pre-filtering system 100 may be configured to receive the input request with a structured output. For example, the content pre-filtering system 100 may receive the signal REQUEST comprising the structured output template 202. The structured output template 202 may indicate a format and/or a pattern of text desired by the user for the output from the AI engine 60. Next, in the step 406, the content pre-filtering system 100 may identify a predefined semantic role in the structured output template 202 as an authoritatively bound role. For example, the role identification module 204 may analyze the semantic roles 222a-222n to determine which of the semantic roles 222a-222n may be authoritatively bound role(s). In the step 408, the content pre-filtering system 100 may classify the authoritatively bound role(s) based on the context for the semantic roles 222a-222n. The role identification module 204 may classify the authoritatively bound role(s) from an analysis of the semantic roles 222a-222n. For example, the role identification module 204 may analyze the authoritatively bound role(s) to determine role attributes (e.g., present the signal RATTR). Next, the method 400 may move to the decision step 410.

In the decision step 410, the content pre-filtering system 100 may determine whether the authoritative data source has been provided with the input. For example, the client device 50 may provide the signal SOURCE along with the signal REQUEST. In another example, the information to respond to the input request may be retrieved from an external source. If the authoritative data source has been provided with the input, then the method 400 may move to the step 414. If the authoritative data source has not been provided with the input, then the method 400 may move to the step 412. In the step 412, the content pre-filtering system 100 may request data from the authoritative data source 70. For example, the content pre-filtering system 100 may generate the signal REQ comprising a request for the authoritative data stored in the authoritative data source 70, and the authoritative data source 70 may provide the signal SOURCE comprising the requested authoritative data. Next, in the step 414, the content pre-filtering system 100 may retrieve a candidate value for the authoritatively bound role. For example, the role identification module 204 may analyze the signal SOURCE for information that may be used as a candidate value to fill the semantic roles 222a-222n that may be identified as the authoritatively bound role(s) (e.g., generate the signal CDVAL). In the step 416, the content pre-filtering system 100 may evaluate the candidate value(s). For example, the constraint validation module 206 may receive the signal CDVAL and/or the signal RATTR to validate one or more constraints. The constraint validation module 206 may be configured to evaluate the candidate value(s) generated by the role identification module 204 based on the role attributes for the authoritatively bound roles. Next, the method 400 may move to the decision step 418.

In the decision step 418, the content pre-filtering system 100 may determine whether the candidate value satisfies the validation constraints. For example, the constraint validation module 206 may compare the candidate value(s) to one or more validation constraints according to the role attribute(s) for the authoritatively bound role(s). If the candidate value satisfies the validation constraints, then the method 400 may move to the step 420. In the step 420, the content pre-filtering system 100 may populate the authoritatively bound role with the validated candidate value. For example, the role identification module 204 and/or the constraint validation module 206 may apply the candidate value(s) to the semantic roles 222a-222n identified as the authoritatively bound role(s) (e.g., provide the signal ABR to the AI engine 60). Next, the method 400 may move to the step 428. In the decision step 418, if the candidate value does not satisfy the validation constraints, then the method 400 may move to the decision step 422.

In the decision step 422, the content pre-filtering system 100 may determine whether the system may operate without a value for the authoritatively bound role. The content pre-filtering system 100 may analyze the structured output template 202 and/or the downstream process 72 to determine whether the system may operate without one or more of the authoritatively bound role(s). If the system cannot operate without the value, then the method 400 may move to the step 424. In the step 424, the content pre-filtering system 100 may prevent the AI engine 60 from receiving the input request. For example, when no suitable data for the structured output template 202 is available, then no input should be provided to the AI engine 60 (e.g., to avoid a possibility of hallucinations). For example, a medical record being unavailable may mean that no prescription may be ordered because sufficient information is not available for forming the prescription. Next, the method 400 may move to the step 430.

In the decision step 422, if the system can operate without the value, then the method 400 may move to the step 426. In the step 426 the content pre-filtering system 100 may identify that the authoritatively bound role may be unavailable. For example, the content pre-filtering system 100 should indicate that the authoritatively bound role is unavailable. In an example, even with missing current year statistics the AI engine 60 may still be capable of making an argument about the best player of all time (along with a caveat that up to date information is unavailable). For example, the signal ABR may be presented to the AI engine 60 with information about which authoritatively bound roles may be unavailable. Next, the method 400 may move to the step 428. In the step 428, when input is provided to the AI engine 60, the AI engine 60 may generate the structured output 208 using the populated authoritatively bound roles (e.g., the validated semantic roles 230a-230n) as fixed while filling in the remaining portions of the structured output 208 using inferred content. For example, the structured output 208 may comprise data from the signal ABR for the validated semantic roles 230a-230n that have been identified as the authoritatively bound roles and the signal PROB for the filled structural components 220a′-220n′ and the validated semantic roles 230a-230n for the semantic roles 222a-222n that have not been identified as authoritatively bound roles. Next, the method 400 may move to the step 430. The step 430 may end the method 400.

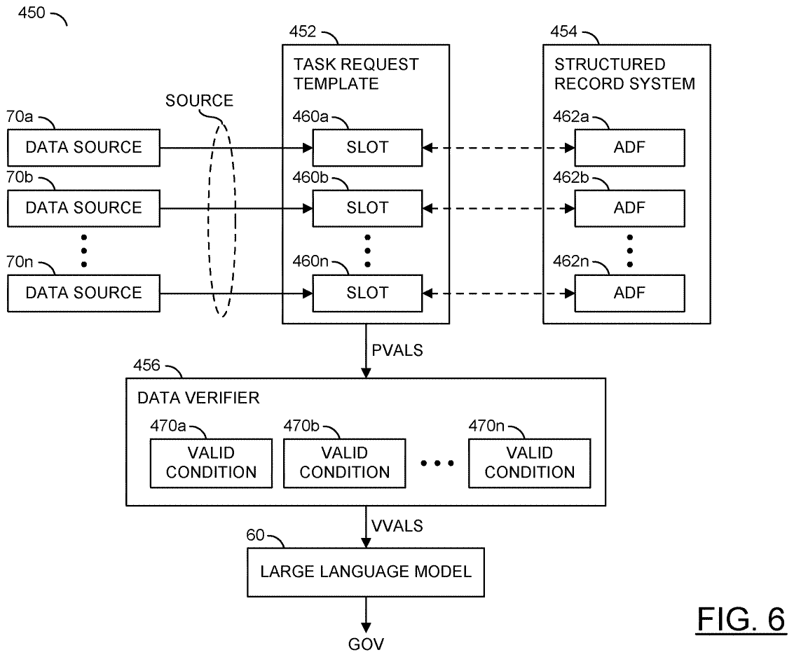

Referring to FIG. 6, a block diagram illustrating authoritative semantic role binding for deterministic generative execution is shown. An authoritative semantic role binding system 450 is shown. The authoritative semantic role binding system 450 may be configured to lock in authoritative semantic roles into parameter slots for a structured record system.

The authoritative semantic role binding system 450 may comprise the AI engine 60 (e.g., a large language model), the authoritative data source 70 (e.g., comprising multiple data sources 70a-70n), a block (or circuit) 452, a block (or circuit) 454, and/or a block (or circuit) 456. The circuit 452 may implement a task template request. The circuit 454 may implement a structured record system. The circuit 456 may implement a data verifier. The authoritative semantic role binding system 450 may comprise other components (not shown). The number, type and/or arrangement of the components of the authoritative semantic role binding system 450 may be varied according to the design criteria of a particular implementation.

The task template request 452 may be an input provided to the content pre-filtering system 100. The task template request 452 may be provided as part of the signal REQUEST. In one example, the task template request 452 may be a structured output template (e.g., similar to the structured output template 202 described in association with FIG. 4). In some embodiments, the task template request 452 may be in a format similar to a format of data stored in the structured record system 454. In some embodiments, the task template request 452 may be provided by the client device 50. In one example, the task template request 452 may comprise a table of desired input values. For example, for a request for athlete statistics, the task template request 452 may be a list of stats desired by the end user (e.g., name, position, jersey number, games played, goals, assists, points, penalty minutes, etc.). In some embodiments, the task template request 452 may be an API request. For example, the task template request 452 may be configured to receive data in a format provided by an API access for the structured record system 454. The particular format and/or data requested in the task template request 452 may be varied according to the design criteria of a particular implementation.

The task template request 452 may comprise a number of blocks 460a-460n. The blocks 460a-460n may be parameter slots for the task template request 452. The parameter slots 460a-460n may comprise locations for data desired to be received from the structured record system 454. In one example, the parameter slots 460a-460n may be semantic roles (e.g., similar to the semantic roles 222a-222n described in association with FIG. 4). One or more of the parameter slots 460a-460n may be authoritatively bound roles identified by the content pre-filtering system 100. For the example of athlete statistics, the parameter slots 460a-460n may be populated from an authoritative source to fill in the statistical data for the particular statistics desired (e.g., the player name, the number worn by the player, the position played of the player, the number of games played, the number of goals, the number of assists, the number of points, the number of penalty minutes, etc.). The particular data to be inserted in the parameter slots 460a-460n may be varied according to the design criteria of a particular implementation.

The structured record system 454 may comprise data in a pre-defined format. The structured record system 454 may be pre-defined in a format for a particular type of data request and/or data output. The task template request 452 may be structured based on the structured record system 454. In some embodiments, the structured record system 454 may be a standardized format. In some embodiments, the structured record system 454 may be the format for an API request. In some embodiments, the structured record system 454 may be the format for a government form. In some embodiments, the structured record system 454 may be the format used for a closed system (e.g., format for documents used internally by a company). In one example, the structured record system 454 may be in a format for requesting a prescription from a pharmacy. The structured record system 454 may be a model document for requesting data from the downstream process 72. The particular type of data provided and/or the type of format of the structured record system 454 may be varied according to the design criteria of a particular implementation.

The structured record system 454 may comprise number of blocks 462a-462n. The blocks 462a-462 may be authoritative data fields. The authoritative data fields 462a-462n may comprise data fields for the format of the structured record system 454. In one example, the authoritative data fields 462a-462n may correspond to a format of data stored in the authoritative data source 70. In another example, the authoritative data fields 462a-462n may be blank spaces to be filled in a form/template document. In some embodiments, the authoritative data fields 462a-462n may comprise sample data to provide a representative example of data types and/or units of data that may be used for filling in the structured record system 454. The particular type of data for the authoritative data fields 462a-462n may be varied according to the design criteria of a particular implementation.

The authoritative semantic role binding system 450 may be configured to associate the parameter slots 460a-460n for the task template request 452 with the authoritative data fields 462a-462n of the structured record system 454. For example, the role identification module 204 may compare the parameter slots 460a-460n with the authoritative data fields 462a-462n to determine the role authoritatively bound roles and/or the role attributes that may enable the appropriate association of the parameter slots 460a-460n with the authoritative data fields 462a-462n. The authoritative semantic role binding system 450 may retrieve data from the authoritative data source 70 for each of the parameter slots 460a-460n based on the association with the authoritative data fields 462a-462n. The content pre-filtering system 100 may generate a signal (e.g., PVALS). The signal PVALS may comprise parameter values for the parameter slots 460a-460n that may have been retrieved from the authoritative data source 70. The parameter values in the signal PVALS for the parameter slots 460a-460n may be presented to the data verifier 456.

For the authoritative semantic role binding system 450, the content pre-filtering system 100 may request data from the authoritative data source 70 in order to retrieve the parameter values from the authoritative data source 70. In the example shown, the authoritative data source 70 may be represented as data sources 70a-70n. One or more of the data sources 70a-70n may generate the signal SOURCE. The signal SOURCE may comprise authoritative parameter values for the parameter slots 460a-460n. In one example, the signal SOURCE may be provided in response to the signal REQ generated by the content pre-filtering system 100 (as shown in association with FIG. 4). In some embodiments, all of the parameter values may be provided by one of the data sources 70a-70n (e.g., all of the parameter values may be available from an official league website for a particular sport, all of the parameter values may be stored in a medical record in a closed system, all the parameter values may be provided from a government website, etc.). In some embodiments, one of the data sources 70a-70n may provide most of the parameter values while another of the data sources 70a-70n may provide remaining parameter values that may not be available from the one of the data sources 70a-70n (e.g., the official league website nhl.com may provide statistics for each player such as goals, assists, points, etc. but may not provide salary cap information, while another website puckpedia. com may provide parameter values for player salary information). In the example shown, each of the data sources 70a-70n may provide one of the parameter values for a corresponding one of the parameter slots 460a-460n, as an illustrative example. The arrangement of data that may be retrieved from the various data sources 70a-70n may be varied according to the design criteria of a particular implementation.

The data verifier 456 may have a similar implementation as the constraint validation module 206 described in association with FIG. 4. For example, the data verifier 456 may analyze the parameter values for the parameter slots 460a-460n to determine whether the data may be suitable for the authoritatively bound roles of the parameter slots 460a-460n. The data verifier 456 may comprise a number of blocks 470a-470n. The blocks 470a-470n may implement validity conditions. The validity conditions 470a-470n may be various constraints used by the content pre-filtering system 100 to determine whether the parameters values for the parameter slots 460a-460n may be suitable for the authoritatively bound roles of the parameter slots 460a-460n. In one example, one of the validity conditions 470a-470n may provide a logic and/or integrity constraint (e.g., whether values have a proper unit, whether a value is a non-negative value, whether a value is within a particular range, whether a value is plausible, etc.). For example, for goals for an athlete, the one of the validity conditions 470a-470n may indicate that the parameter value should be an integer value, and should not be a negative number. For example, for goals for an athlete, a pre-defined range may be from 0-100 and the data verifier 456 may flag, but not necessarily disallow, values above 100 (e.g., 100 goals in a season may be unlikely but may not necessarily be impossible). In another example, one of the validity conditions 470a-470n may be a data freshness (or recency). For example, the data freshness constraint may indicate a time window for acceptable data. For example, for statistics for a retired athlete, there may be no data freshness requirement (e.g., the data is archived and may not change again). For example, for statistics for an active athlete, the data freshness may be data from within the past week (e.g., an active athlete may be acquiring more goals in the ongoing season). In yet another example, one of the validity conditions 470a-470n may be a trust level for the data sources 70a-70n. For example, data retrieved from some sources may be rejected (e.g., data from a flat earth website may be rejected when the parameter slots 460a-460n relate to information about the solar system, but the same flat earth website may be suitable when the parameter slots 460a-460n relate to information about conspiracy theories). The particular types of the validity conditions 470a-470n may be varied according to the design criteria of a particular implementation.

The data verifier 456 may verify the parameters using one or more of the validity conditions 470a-470n. The data verifier 456 may block completion of the generative task request (e.g., provided as the task template request 452 in the signal REQUEST) when at least one of the parameter slots 460a-460n lacks a parameter value that satisfies the validity conditions 470a-470n. The authoritative semantic role binding system 450 may prevent probabilistic token-level inference from substituting alternative values for the validity conditions 470a-470n during completion of the generative task. The authoritative semantic role binding system 450 may inject only the parameter values that satisfy the validity conditions 470a-470n.

The data verifier 456 may generate a signal (e.g., VVALS) in response to the signal PVALS. The signal VVALS may comprise validated parameter values for the parameter slots 460a-460n. The signal VVALS may be provided for a generative reasoning process by the AI engine 60. Injecting only the parameter values retrieved that satisfy the parameter slots 460a-460n into the generative reasoning process of the AI engine 60 may enable binding the parameter values injected to the required semantic roles associated with the authoritative data fields 462a-462n. Preventing probabilistic token-level inference substituting alternative values may enforce a deterministic override of probabilistic completion with respect to the required semantic roles.

A task request may be received together with a template defining required semantic slots (e.g., the task template request 452 with the parameter slots 460a-460n may be provided with the signal REQUEST). Each of the parameter slots 460a-460n may correspond to a semantic role that must be populated in order to complete the task. The authoritative semantic role binding system 450 may retrieve candidate parameter values from one or more data sources 70a-70n associated with the authoritative data fields 462a-462n. The retrieved values may be evaluated by the data verifier 456 to determine whether specified validity conditions 470a-470n are satisfied. The validity conditions 470a-470n may include freshness checks, completeness verification, or other integrity constraints. Candidate values that satisfy the validity conditions 470a-470n may be provided to the AI engine 60 as validated parameter values in the signal VVALS. The generative model implemented by the AI engine 60 may then produce narrative and/or contextual output while relying on the validated parameter values to populate the required semantic roles. If one of the parameter slots 460a-460n cannot be populated with validated data, the authoritative semantic role binding system 450 may block completion of the output rather than allowing the AI engine 60 to fill the role through probabilistic inference.

The AI engine 60 may generate the signal GOV in response to the signal VVALS. The signal GOV may comprise the validated authoritative data for the authoritatively bound semantic roles of the parameter slots 460a-460n as well as probabilistically inferred content generated by the AI engine 60 for the remaining content to respond to the request of the end user. In some embodiments, the signal GOV may be presented to the client device 50. In some embodiments, the signal GOV may be presented to the downstream process 72.

The authoritative semantic role binding system 450 may enable deterministic enforcement of required semantic parameters while preserving the generative capabilities of the language model for explanatory or contextual content. The authoritative semantic role binding system 450 may govern how structured outputs may be allowed to populate certain fields before execution. The authoritative semantic role binding system 450 may receive a prompt that may produce a structured output, identify roles that must be deterministically bound before completion, retrieve candidate values from authoritative sources, validate the candidate values, prevent the generative model from filling those roles if the values are missing or invalid and/or block the downstream process until the roles are properly populated. The authoritative semantic role binding system 450 may be used for hospital ordering systems, banking transaction approvals, insurance claim generation, automated compliance filings, legal document assembly, etc.

Referring to FIG. 7, a method (or process) 500 is shown. The method 500 may identify authoritatively bound semantic roles in response to analyzing a request. The method 500 generally comprises a step (or state) 502, a step (or state) 504, a decision step (or state) 506, a step (or state) 508, a step (or state) 510, a step (or state) 512, a decision step (or state) 514, a step (or state) 516, a step (or state) 518, a step (or state) 520, a step (or state) 522, a step (or state) 524, and a step (or state) 526.

The step 502 may start the method 500. In the step 504, the content pre-filtering system 100 may receive an input as a natural language query from an end user. For example, the content pre-filtering system 100 may receive the signal REQUEST from the client device 50. Next, in the decision step 506, the content pre-filtering system 100 may determine whether the request includes a structured input template. The content pre-filtering system 100 may determine whether the input comprises the structured output template 202. For example, the role identification module 204 may determine when the signal REQUEST comprises the structured output template 202 (or similarly the task template request 452). If the request does include a structured output template, then the method 500 may move to the step 508. In the step 508, the role identification module 204 may select classified elements (e.g., elements pre-classified in the structured output template 202 as being an authoritatively bound role) from the structured output template 202. For example, in some embodiments, the structured output template 202 may indicate which of the semantic roles 222a-222n may be authoritatively bound roles. If the structured output template 202 indicates which of the semantic roles 222a-222n are authoritatively bound roles, then the role identification module 204 may select the pre-defined authoritatively bound roles as identified in the structured output template 202. Next, the method 500 may move to the decision step 514.

In the decision step 506, if the request does not include the structured output template 202, then the method 500 may move to the step 510. In the step 510, the content pre-filtering system 100 may analyze the query content to detect verifiable elements for the response. For example, if the request does not include the structured output template 202, the role identification module 204 may analyze the natural language query content to detect factual assertions, verifiable elements and/or inferential elements. Next, in the step 512, the content pre-filtering system 100 may classify the detected elements. For example, the detected elements may be classified (e.g., numerical, categorical, verifiable, inferential, etc.) by the role identification module 204. Next, the method 500 may move to the decision step 514.

In the decision step 514, the role identification module 204 may check whether an authoritative source is available for the classified elements. For example, in some scenarios, the authoritative source may be provided by the client device 50, and/or retrievable from the authoritative data source 70. If there is an authoritative source available for the classified elements, then the method 500 may move to the step 516. In the step 516, the role identification module 204 may designate the authoritatively bound roles from the classified element portions of the response. Next, in the step 518, the content pre-filtering system 100 may retrieve data from the authoritative source. For example, the content pre-filtering system 100 may generate the signal REQ in order to receive the signal SOURCE from the authoritative data source 70 to retrieve the authoritative data for the authoritatively bound role(s). In the step 520, the constraint validation module 206 may validate the retrieved data based on the authoritatively bound role. For example, the constraint validation module 206 may generate the signal ABR in response to the signal CDVAL and/or the signal RATTR. The populated candidate values (e.g., the validated values) may be stored in a fixed buffer and may not be modified by the AI engine 60. Next, the method 500 may move to the step 522.

In the decision step 514, if the authoritative source does not exist for the classified elements, the method 500 may move to the step 522. In the step 522, the content pre-filtering system 100 may enable the AI engine 60 to perform inference on the portions of the structured output 208 that cannot be determined from the authoritative source. Next, in the step 524, the AI engine 60 may generate a response according to the classified elements. For example, the AI engine 60 may use the validated data for the authoritatively bound roles stored in the fixed buffer to fill in the validated semantic roles 230a-230n of the structured output 208 and may use probabilistically inferred content to fill out remaining portions of the structured output 208. If no authoritative data is available, the AI engine 60 may indicate which data was unavailable. Next, the method 500 may move to the step 526. The step 526 may end the method 500.

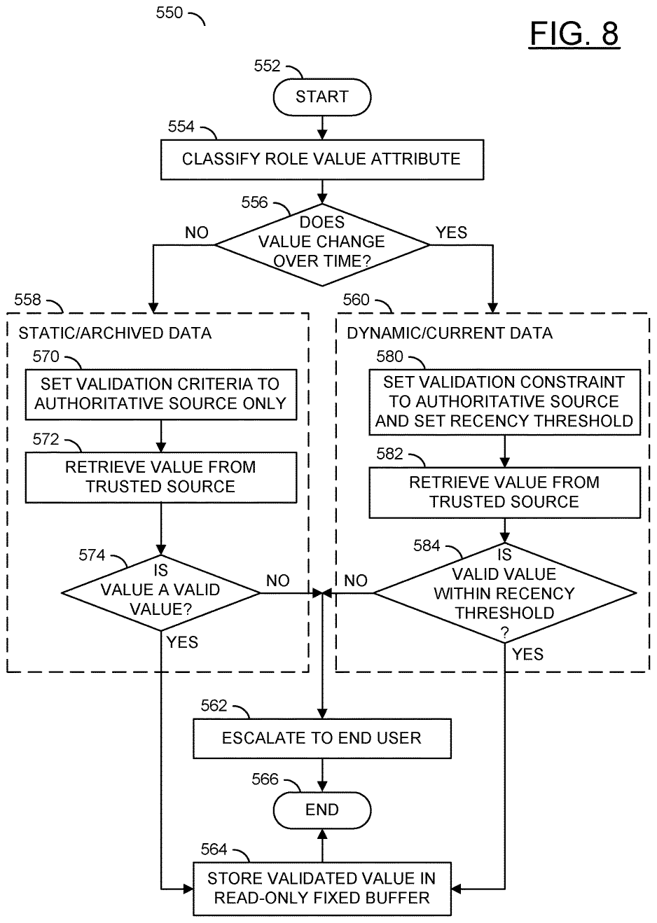

Referring to FIG. 8, a method (or process) 550 is shown. The method 550 may classify a role value attribute for an authoritatively bound semantic role. The method 550 generally comprises a step (or state) 552, a step (or state) 554, a decision step (or state) 556, a step (or state) 558, a step (or state) 560, a step (or state) 562, a step (or state) 564, and a step (or state) 566.

The step 552 may start the method 550. In the step 554, the content pre-filtering system 100 may classify the role value attribute(s). For example, the role identification module 204 may identify the authoritatively bound role(s) for a request and classify the role attribute values (e.g., generate the signal RATTR). Next, the method 550 may move to the decision step 556. In the decision step 556, the role identification module 204 may determine whether the value for the authoritatively bound role may change over time. In one example, the role may be classified as to whether the value does not change over time or is dynamically changing data. For example, in a query related to athletes, an active player may have live and/or dynamic data while a retired player may have archived data that may not change. If the value does not change (e.g., archived data), the method 550 may move to the step 558.

The step 558 may comprise a sub-process for static and/or archived data. The step 558 may comprise a step (or state) 570, a step (or state) 572, and/or a decision step (or state) 574. In the step 570, the constraint validation module 206 may set validation criteria to a particular source (e.g., the authoritative data source 70). In one example, the particular source may be a sports almanac. In another example, the particular source may be a website that comprises archived sports statistics (e.g., historical data from already completed seasons). Next, in the step 572, the content pre-filtering system 100 may retrieve the values from the authoritative data source 70. For example, for a query related to Wayne Gretzky (e.g., a retired hockey player), the career goals may be 894, which may never change. Next, the step 558 may move to the decision step 574. In the decision step 574, the constraint validation module 206 may determine whether the value is a valid value. Whether the value is valid may be determined based on the validity conditions 470a-470n. If the validated value is retrieved, then the step 558 may end and the method 550 may move to the step 564. If a validated value cannot be retrieved, then the step 558 may end and the method 550 may move to the step 562.

The step 560 may comprise a sub-process for dynamically updating data. The step 560 may comprise a step (or state) 580, a step (or state) 582, and/or a decision step (or state) 584. In the step 580, the constraint validation module 206 may set validation criteria to a reliable source (e.g., the authoritative data source 70) and/or set a recency threshold. For example, if the query is about who is the best player in the past month, the source may be the official league website and the recency window may be set to the past 30 days. Next, in the step 582, the content pre-filtering system 100 may retrieve the values from the authoritative data source 70. For example, for a query related to the best player in the past month, the particular time range may change based on when the query is provided and the statistical data may be needed from the past 30 days from the time of the request. Next, the step 560 may move to the decision step 584. In the decision step 584, the constraint validation module 206 may determine whether the value is a valid value within the recency threshold. Whether the value is valid may be determined based on the validity conditions 470a-470n set by the constraint validation module 206 in response to the query. If the validated value is retrieved, then the step 560 may end and the method 550 may move to the step 564. If a validated value cannot be retrieved, then the step 560 may end and the method 550 may move to the step 562.

In the step 562, the content pre-filtering system 100 may escalate the response to the end user. For example, whether the value is an archived value or a dynamic value, if valid data is unavailable, then an issue may be elevated to the end user. For example, the user may receive a message that the AI engine 60 cannot provide an accurate answer. In another example, the user may receive a message about which source to check. Next, the method 550 may move to the step 566.

In the step 564, the content pre-filtering system 100 may store the validated value in a read-only fixed buffer. For example, the value is an archived value or a dynamic value, if valid data is available, then the content pre-filtering system 100 may store the valid value in the fixed buffer as the populated authoritatively bound role. In some embodiments, the valid value stored in the fixed buffer may be presented to the AI engine 60 to generate the response with inferred content around the fixed validated value. In some embodiments, the content pre-filtering system 100 may receive the probabilistically inferred data from the AI engine 60 and assemble the governed output by combining both the fixed validated value for the authoritatively bound role(s) and adding the inferred content around the fixed validated value(s). Next, the method 550 may move to the step 566. The step 566 may end the method 550.

Referring to FIG. 9, a block diagram illustrating a memory buffer architecture for a governance layer is shown. A governance layer architecture 600 is shown. The governance layer architecture 600 may comprise the client device 50, the AI engine 60, the authoritative data source 70, the downstream process 72, the content pre-filtering system 100, and/or the structured output 208. In the example shown, the governance layer architecture 600 may be implemented as an input-side governance layer and/or an output-side governance layer.

The client device 50 may provide the input signal REQUEST to the content pre-filtering system 100. The authoritative data source 70 may receive the signal REQ from the content pre-filtering system 100. The authoritative data source 70 may provide the input signal SOURCE to the content pre-filtering system 100. The AI engine 60 may receive the read-only signal ABR and/or the signal REQUEST from the content pre-filtering system 100. For example, the content pre-filtering system 100 may be configured to forward the input request from the client device 50 to the AI engine 60. The AI engine 60 may provide the input signal PROB to the content pre-filtering system 100. The downstream process 72 may receive the output signal GOV from the content pre-filtering system 100. The output signal GOV may comprise the structured output 208. Other input/output signals may be received by and/or output by the content pre-filtering system 100. The particular number, type and/or format of the signals communicated by the content pre-filtering system 100 may be varied according to the design criteria of a particular implementation.

The content pre-filtering system 100 may comprise the role identification module 204, the constraint validation module 206, a block (or circuit) 602, a block (or circuit) 604 and/or a block (or circuit) 606. The circuit 602 may implement a data retrieval module. The circuit 604 may implement a memory buffer. The circuit 606 may implement an assembly module. The content pre-filtering system 100 may comprise other components (not shown). The number, type and/or arrangement of the components implemented by the content pre-filtering system 100 may be varied according to the design criteria of a particular implementation.

The role identification module 204 may be configured to analyze the signal REQUEST. The role identification module 204 may have a similar implementation as described in association with FIG. 4. The role identification module 204 may generate the signal RATTR in response to the signal REQUEST. For example, the role identification module 204 may identify authoritatively bound roles in the structured output template 202 in response to the signal REQUEST. The role identification module 204 may determine the authoritatively bound roles and/or the role attributes for the authoritatively bound roles. The signal RATTR may be presented to the data retrieval module 602 and/or the constraint validation module 206.

The data retrieval module 602 may receive the signal RATTR from the role identification module 204. The data retrieval module 602 may be configured to access the authoritative data source 70. For example, the data retrieval module 602 may be configured to generate the signal REQ to request information from the authoritative data source 70 and receive the signal SOURCE comprising the data retrieved by the authoritative data source 70. In some embodiments, the signal REQ may comprise login credentials for a closed system, API call data for the authoritative data source 70, a handshake protocol, etc. For example, the data retrieval module 602 may be configured to perform HTTP requests, API requests, provide login credentials, etc. In some embodiments, the data retrieval module 602 may comprise a list of trusted sources and/or a trust ranking for various data sources. In the example shown, the authoritative data source 70 is shown as an illustrative example of one or more available data resources. In some embodiments, the data retrieval module 602 may select one or more of the data sources 70a-70n based on a trust ranking and/or the role attributes for the authoritatively bound role(s). For example, the data retrieval module 602 may determine which sources may be a trusted source for the particular authoritatively bound role(s). The data retrieval module 602 may retrieve the candidate values from the authoritative data source 70. The data retrieved by the data retrieval module 602 (e.g., the candidate values) may be provided to the constraint validation module 206 for validation. The data retrieval module 602 may communicate the signal CDVAL to the constraint validation module 206 in response to the signal RATTR and the signal SOURCE.

The constraint validation module 206 may be configured to analyze the candidate value(s) in the signal CDVAL and/or the role attribute information for the authoritatively bound roles in the signal RATTR. The constraint validation module 206 may have a similar implementation as described in association with FIG. 4 and/or as the data verifier 456 described in association with FIG. 6. The constraint validation module 206 may be configured to validate and/or verify the candidate values retrieved from the authoritative data source 70. Data that has been validated by the constraint validation module 206 may be stored in the memory buffer 604. The validated data used to populate the authoritatively bound role(s) may be provided to the memory buffer 604 via the signal ABR. The constraint validation module 206 may generate the signal ABR in response to the signal CDVAL and/or the signal RATTR.

The memory buffer 604 may be configured to store data. The memory buffer 604 may store data corresponding to each of the input requests. For example, the memory buffer 604 may store the input request provided in the signal REQUEST and/or the populated authoritatively bound role(s) provided in the signal ABR. In one example, the memory buffer 604 may forward the input request from the client device 50 to the AI engine 60 (e.g., after the content pre-filtering system 100 has populated the authoritatively bound roles first by analyzing the request). In another example, the client device 50 may communicate the signal REQUEST to both the content pre-filtering system 100 and the AI engine 60. Generally, enabling the memory buffer 604 to forward the request to the AI engine 60 may enable the content pre-filtering system 100 to be transparent to the end user. In some embodiments, the memory buffer 604 may receive the signal PROB from the AI engine 60. For example, the memory buffer 604 may store the probabilistically inferred data generated by the AI engine 60. In some embodiments, the memory buffer 604 may communicate the signal ABR and/or forward the signal PROB to the assembly module 606. The number, type and/or format of the data signals communicated by the memory buffer 604 may be varied according to the design criteria of a particular implementation.

The memory buffer 604 may comprise a block (or circuit) 610 and/or a block (or circuit) 612. The circuit 610 may implement a fixed buffer. The circuit 612 may implement a generative buffer. The memory buffer 604 may comprise other components (not shown). For example, the memory buffer 604 may comprise storage for the input request in the signal REQUEST. The number, type and/or arrangement of the components implemented by the memory buffer 604 may be varied according to the design criteria of a particular implementation.

The fixed buffer 610 may be configured to receive the signal ABR. The fixed buffer 610 may store the populated authoritatively bound roles. For example, the fixed buffer 610 may receive the validated candidate values from the constraint validation module 206 that may populate the authoritatively bound roles. The fixed buffer 610 may be configured to store the validated semantic roles 230a-230n. The fixed buffer 610 may be configured to forward the information in the signal ABR to the AI engine 60 and/or to the assembly module 606. The fixed buffer 610 may be read only by the AI engine 60. For example, the AI engine 60 may be forbidden from changing the data in the fixed buffer 610. The fixed buffer 610 may be writable to by the content pre-filtering system 100 (e.g., by the constraint validation module 206).

The fixed buffer 610 may store the validated data with read-only access permissions enforced with respect to the AI engine 60. The AI engine 60 may reference the authoritative data provided by the authoritative data source 70 from the signal ABR stored in the fixed buffer 610 when generating the governed output. The AI engine 60 may not modify, paraphrase, reword, or otherwise alter the text and/or other content stored by the fixed buffer 610 (e.g., the AI engine 60 may generate output without substitution for the authoritatively bound roles). In some embodiments, the signal ABR may comprise a weight value. In one example, the weight value may be provided with a largest weight value usable by the AI engine 60 to prevent the AI engine 60 from changing the populated authoritatively bound roles stored in the fixed buffer 610. The particular method of preventing the AI engine 60 from changing the content stored in the fixed buffer 610 may be varied according to the design criteria of a particular implementation.

The generative buffer 612 may be configured to receive the signal PROB. The generative buffer 612 may be configured to store the probabilistically inferred content generated by the AI engine 60. The generative buffer 612 may be writeable to by the AI engine 60. For example, the generative buffer 612 may receive the probabilistically inferred content generated by the AI engine 60. The generative buffer 612 may be configured to store the filled structural components 220a′-220n′ and/or any of the validated semantic roles 230a-230n that have not been stored in the fixed buffer 610 (e.g., for the semantic roles that have not been identified as the authoritatively bound roles). The generative buffer 612 may be configured to forward the information in the signal PROB to the assembly module 606. Generally, the generative buffer 612 may be not writable by components of the content pre-filtering system 100 (e.g., the generative buffer 612 may be writable by the AI engine 60).

The probabilistically inferred content generated by the AI engine 60 may support, enhance and/or augment the populated authoritatively bound roles in the fixed buffer 610 but may not alter the populated authoritatively bound roles. The governance layer architecture 600 may prevent failure modes (e.g., altering, paraphrasing, misquoting, etc.) by storing the exact text in the fixed buffer 610 with read-only access permissions and by requiring the AI engine 60 to reference the fixed buffer 610 content without modification when generating all sections of the governed output.

The governance layer architecture 600 may maintain two completely separate buffers (e.g., the fixed buffer 610 and the generative buffer 612) with no shared write access. The fixed buffer 610 may be populated by the content pre-filtering system 100 with authoritatively bound content before the AI engine 60 runs. The generative buffer 612 may receive output from the AI engine 60 only. The architectural components of the governance layer architecture 600 may be the fixed buffer 610 with read-only access permissions for the generative process, the generative buffer 612 that receives only model-generated content, and/or a buffer controller implemented by the memory buffer 604 that may enforce the access permissions (e.g., prevents cross-buffer writes). The data stored in the fixed buffer 610 and the generative buffer 612 may be merged by the assembly module 606 according to the structured output template 202.

The assembly module 606 may receive the signal ABR and/or the signal PROB from the memory buffer 604. The assembly module 606 may be configured to combine the content from the fixed buffer 610 and the generative buffer 612 in correct structural positions to produce the final output (e.g., the governed output). The governed output of the assembly module 606 may be the structured output 208 provided in the signal GOV. In some embodiments, the signal GOV may be presented to the downstream process 72. The downstream process 72 may execute one or more actions in response to the structured output 208.

The assembly module 606 may be configured to perform post-inference token substitution.

The assembly module 606 may be configured to read an output sequence of tokens, identify flagged positions for the tokens and generate the governed output comprising assembled tokens. The output sequence of tokens may comprise the output of the fixed buffer 610 and/or the generative buffer 612. In one example, the assembly module 606 may be configured to swap in, verbatim, the sequence of tokens of the populated authoritatively bound roles stored in the fixed buffer 610 into the output sequence of tokens of the generative buffer 612. For example, the probabilistically inferred sequence of tokens generated by the AI engine 60 may comprise content for the authoritatively bound roles that may or may not be accurate and the assembly module 606 may ensure accuracy by swapping out the tokens from the probabilistically inferred content with the tokens from the fixed buffer 610 into the flagged positions for the authoritatively bound roles.

The assembly module 606 may perform the token assembly outside of the operation(s) of a transformer and/or without providing input for a second pass to the transformer. The assembly module 606 may perform the assembly without involvement from a LLM. The assembly module 606 may perform a direct memory read from the fixed buffer 610 and perform a token-level string operations on the output sequence of tokens. Details of the token assembly performed by the assembly module 606 may be described in association with U.S. Provisional Application No. 64/026,578, filed on Apr. 2, 2026, appropriate portions of which are incorporated by reference. The particular method of token assembly performed by the assembly module 606 may be varied according to the design criteria of a particular implementation.

In one example, the fixed buffer 610 may comprise tokens corresponding to the authoritatively bound roles for athlete statistics (e.g., Player Name: Connor McDavid, Team: Edmonton, Number: 97, Games Played: 75, Goals: 43, Assists: 82, Points: 125, Penalty Minutes: 36, etc.) and/or a date of retrieval (e.g., a timestamp). The tokens in the fixed buffer 610 may be stored as a vector of values and/or in a matrix format. In the same example, the input request may comprise details about the best player currently in the NHL. The AI engine 60 may generate narrative content about the best player in the NHL. The narrative content may comprise the probabilistically inferred content generated by the AI engine 60 and stored in the generative buffer 612. For example, the narrative content may describe various details about how hockey player performance is measured, why the decision was made for the particular player, historical comparisons, etc. The probabilistically inferred content may comprise statistics gathered by the AI engine 60. However, the content pre-filtering system 100 may treat the statistics gathered by the AI engine 60 as inherently untrustworthy. The assembly module 606 may read the tokens in the output sequence from the generative buffer 612 (e.g., in the signal PROB). The assembly module 606 may identify locations at which the inferred content corresponds to the authoritatively bound roles stored in the fixed buffer 610 (e.g., in the signal ABR). The assembly module 606 may swap in the tokens from the authoritatively bound roles for the athlete statistics at the locations in the output sequence of the probabilistically inferred content. Swapping in the tokens of the authoritatively bound roles may replace the potentially untrustworthy values generated by the AI engine 60.

In some embodiments, the content pre-filtering system 100 may operate as an input-side only governance layer. For example, the content pre-filtering system 100 may provide the populated authoritatively bound roles to the AI engine 60, may not control how the AI engine 60 operates, and may not adjust the output of the AI engine 60. For the input-side only governance layer, the fixed buffer 610 may provide the populated authoritatively bound roles stored in the fixed buffer 610 to the AI engine 60 as the signal ABR. The AI engine 60 may generate the structured output 208 in response to the signal REQUEST and/or the signal ABR. For example, the tokens provided from the fixed buffer 610 may be given a high weight value to ensure that the AI engine 60 does not perform a replacement of the authoritatively bound roles when generating the probabilistically inferred content. When operating as the input-side only governance layer, the AI engine 60 may not benefit from providing the probabilistically inferred content to the generative buffer 612 for storage. Since the content pre-filtering system 100 may directly alter the output, then the content pre-filtering system 100 may not benefit from storing the probabilistically inferred content in the generative buffer 612. The AI engine 60 may generate the signal GOV′, comprising the governed output. The signal GOV′ may comprise the structured output 208, which may be used by the downstream process 72.

In some embodiments, the content pre-filtering system 100 may operate as an output-side only governance layer. For example, the AI engine 60 may generate the probabilistically inferred content and the content pre-filtering system 100 may add in the populated authoritatively bound roles using the assembly module 606. Since the content pre-filtering system 100 may combine the probabilistically inferred content from the AI engine 60 with the populated authoritatively bound roles, the content pre-filtering system 100 may store the probabilistically inferred content generated by the AI engine 60 in the generative buffer 612. For example, the content pre-filtering system 100 may analyze the signal REQUEST to determine and then populate the authoritatively bound roles and store the tokens for the populated authoritatively bound roles in the fixed buffer 610. The content pre-filtering system 100 may forward the signal REQUEST to the AI engine 60 to enable the AI engine 60 to generate the probabilistically inferred content in response to the signal REQUEST. The signal PROB may be communicated to the content pre-filtering system 100 to enable the probabilistically inferred content to be stored in the generative buffer 612. Since the content pre-filtering system 100 may assemble the governed output, when operating as an output-side only governance layer, the content pre-filtering system 100 may not benefit from providing the signal ABR to the AI engine 60. The assembly module 606 may combine the probabilistically inferred content from the generative buffer 612 with the populated authoritatively bound roles from the fixed buffer 610 to generate the structured output 208.

The structured output 208 may be provided to the downstream process 72. In some embodiments, the content pre-filtering system 100 may operate as an input side and output side governance layer. Whether the content pre-filtering system 100 implements an input-side only governance layer, an output-side only governance layer or a combination input-side/output-side governance layer may be varied according to the design criteria of a particular implementation.

The content pre-filtering system 100 may enable the AI engine 60 to be permitted to infer values for the predefined semantic roles other than the authoritatively bound role. For example, the AI engine 60 may not change the authoritatively bound roles stored in the fixed buffer 610 but may provide the probabilistically inferred content for data other than the authoritatively bound roles. In one example, the AI engine 60 may generate narrative content that references the populated authoritatively bound role. The signal ABR may provide the content for the authoritatively bound role, and the content pre-filtering system 100 may prevent modification of the populated authoritatively bound role by the AI engine 60. However, the narrative content (e.g., the probabilistically inferred content) may be generated with respect to and/or by referring to the authoritatively bound roles. In an example, the AI engine 60 may perform probabilistic reasoning using the populated authoritatively bound role as a deterministic parameter.

The role identification module 204 may identify at least one of the predefined semantic roles as the authoritatively bound roles by analyzing the request from the end user (e.g., analyzing the signal REQUEST). The role identification module 204 may detect one or more factual assertions, numerical values, and/or verifiable data elements within a prospective response to the request, which may be susceptible to authoritative grounding from the authoritative data source 70. One of the validity conditions 470a-470n for the authoritatively bound roles may be a recency threshold. For example, the constraint validation module 206 may determine the recency threshold based on whether the authoritatively bound role corresponds to a static historical value or a dynamically changing current value.

In some embodiments, the authoritative data source 70 may be a closed system (e.g., only accessible from the client device 50 and/or with permission from the client device 50). For example, the data retrieval module 602 may be configured to maintain a designation record identifying the closed system as the authoritative data source 70 for one or more of the predefined semantic roles. The data retrieval module 602 may be configured to access the closed system via a designated application programming interface in response to the designation record. For example, the data retrieval module 602 may comprise a memory configured to store login credentials (or receive login credentials from the client device 50) for each designation record. The data retrieval module 602 may use the designated API to access the authoritative data source 70. The data retrieval module 602 may retrieve the value from the authoritative data source 70 via the API and the values may be stored in the fixed buffer 610. The data stored in the fixed buffer 610 may be deemed to be authoritative. The AI engine 60 may be prevented from performing probabilistic substitution for the data stored in the fixed buffer 610.

In one example of a closed system for the authoritative data source 70, the closed system may be a medical record portal and the data source (e.g., the data provided in the signal SOURCE) may comprise a medical record. For example, for dosing a drug such as Vancomycin (e.g., a powerful intravenous antibiotic used to treat serious bacterial infections, particularly when other antibiotics have failed or when the bacteria are resistant), dosing may be high-stakes, safety critical and/or accuracy-critical (e.g., the therapeutic window may be narrow where too little may not work and too much may be nephrotoxic). Dosing may be weight-based and depend on current kidney function, which is measured by creatinine clearance. The patient weight, creatinine level, known allergies, current medications, etc. may be the authoritatively bound roles (e.g., every one has to come from the actual medical record). If the AI engine 60 guesses an average adult weight instead of retrieving the real value, the dose could be wrong in a way that kills the patient. The content pre-filtering system 100 may be configured to block execution of AI engine 60 when the data source cannot be retrieved from the closed system.

In some embodiments, the authoritative data source 70 may be supplied by the end user. For example, the signal SOURCE may comprise a pre-defined data segment supplied by the end user. In one example, the data segment may be a selection of text to be reproduced by the AI engine 60 word for word. For example, the data segment may be a citation. The data retrieval module 602 may receive the data segment, which may be stored in the fixed buffer 610.

In some embodiments, the authoritative data source 70 may be a third party. The signal SOURCE may comprise data retrieved from the third party. In one example, the third party may be identified by the end user in the signal REQUEST. In another example, the third party may be a government resource (e.g., a government website) and the acquired information may be regulations (e.g., construction codes, traffic regulations, zoning bylaws, etc.). In some embodiments, the data retrieval module 602 may perform an analysis of available resources in response to the authoritatively bound role identified by the role identification module 204. The data retrieval module 602 may select the third party in response to the analysis and retrieve the information from the authoritative data source 70. In one example, the data retrieval module 602 may store a ranking for trust levels for the available third party resources. In another example, the data retrieval module 602 may search other resources for a trust level of the third party resources. In yet another example, the data retrieval module 602 may generate a question for the end user comprising a list of the available resources. The data retrieval module 602 may then select the third party based on the selection from the list provided by the end user in response to the question.

The constraint validation module 206 may determine whether the candidate value (e.g., the signal CDVAL) satisfies the validity conditions 470a-470n before storing the populated authoritatively bound role in the fixed buffer 610. In one example, the validation constraints may be a data freshness threshold determined based on the authoritatively bound role. For example, when the authoritatively bound role is determined from a medical record and the data freshness threshold may comprise a time limitation for a patient medical attribute in response to a drug dosage (e.g., the patient attribute such as a patient weight must have been determined within the time limitations). In an example, the patient medical attributes may comprise one or more of a blood glucose level, a patient weight, a creatinine level, known allergies, current medications, etc.

The AI engine 60 may generate explanatory and/or analytical content associated with the structured output 208 while maintaining the populated authoritatively bound role as fixed. The populated authoritatively bound role may constrain the reasoning performed by the AI engine 60 during generation of the remaining portions of the structured output 208. For example, since the fixed buffer 610 may not be modified by the AI engine 60, the populated authoritatively bound role stored in the fixed buffer 610 may constrain the reasoning performed by the AI engine 60. The signal ABR may be provided to the AI engine 60. For example, the populated authoritatively bound role may be inserted into a prompt, execution context, and/or structured template that may be provided to the AI engine 60.

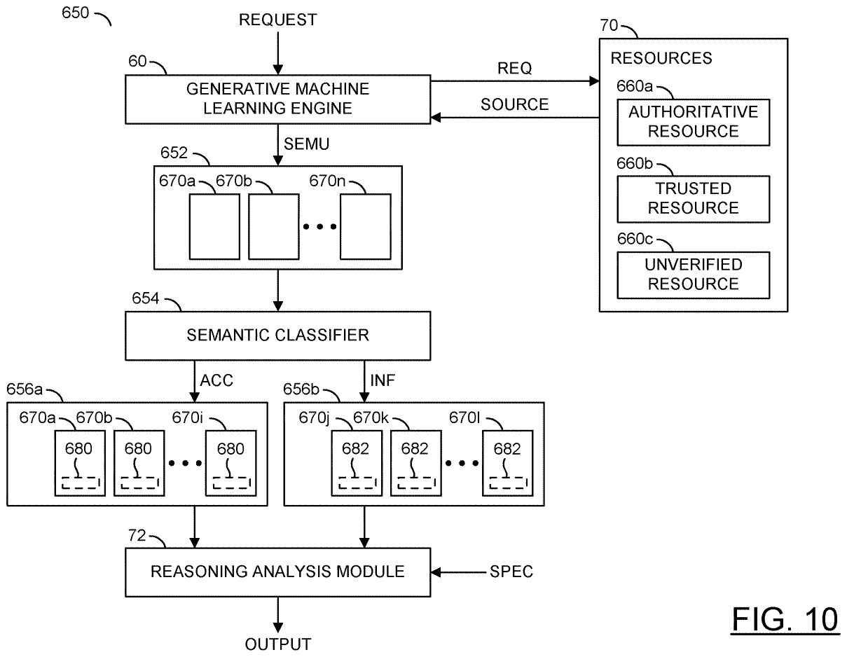

Referring to FIG. 10, a block diagram illustrating epistemic tagging control is shown. The epistemic tagging control system 250 may be configured to classify content retrieved from the authoritative data source 70 and apply metadata tags that may be used downstream to identify which content comprises authoritative content and which content comprises probabilistically inferred content.

The epistemic tagging control system 650 may comprise the AI engine 60, the authoritative data source 70, the downstream process 72, generated content 652, a block (or circuit) 654, and/or tagged semantic units 656a-656b. The circuit 654 may implement a semantic classifier. The epistemic tagging control system 650 may comprise other components (not shown). The number, type and/or arrangement of the components of the epistemic tagging control system 650 may be varied according to the design criteria of a particular implementation.

The authoritative data source 70 may comprise various types of content sources 660a-660c. The content sources 660a-660c may comprise potential sources of content (e.g., sources that may potentially be used as the authoritative data source for the authoritatively bound roles) with different levels of trust. In the example shown, the content source 660a may be an authoritative resource. For example, authoritative resources may be primary literature, an official website, a government resource, a pre-defined document, data from a pre-defined closed system, etc. In the example shown, the content source 660b may be a trusted resource. For example, the trusted resource may be pre-approved and/or well-known resources that provide reliable content. In the example shown, the content source 660c may be an unverified resources. For example, the unverified resources may have an unknown trust level, may be known to produce false information, may have unreliable data, a resource that has not been updated within a particular time frame, etc. The particular type of content sources 660a-660c selected may be determined by the data retrieval module 602. In some embodiments, the user may prefer to receive data from the unverified resource 660c. For example, the signal REQUEST may comprise a parameter that indicates which of the content sources 660a-660c may be acceptable. The particular types of the content sources 660a-660c and/or the method of determining which of the content sources 660a-660c may be trustworthy and which may be unreliable may be varied according to the design criteria of a particular implementation.

The AI engine 60 may be configured to generate the generated content 652 in response to the signal REQUEST. For example, the AI engine 60 may access the authoritative data source 70 (via the signal REQ) and receive the signal SOURCE comprising the data retrieved from the authoritative data source 70 in response to the input request provided by the signal REQUEST. The AI engine 60 may generate a signal (e.g., SEMU). The signal SEMU may comprise the generated content 652.

The generated content 652 may comprise a number of blocks 670a-670n. The semantic units 670a-670n may comprise semantic units. In one example, the semantic units 670a-670n may comprise output tokens generated by the AI engine 60. The semantic units 670a-670n of the generated content 652 may be provided to the semantic classifier 654 as the signal SEMU.

The semantic classifier 654 may be configured to receive the signal SEMU. The semantic classifier 654 may be configured to classify the semantic units 670a-670n based on an epistemic status. The semantic classifier 654 may determine whether the semantic units 670a-670n comprise data from the authoritative data source 70 and/or probabilistically inferred content generated by the AI engine 60. In some embodiments, for the content from the authoritative data source 70, the semantic classifier 654 may further classify according to a trust level of the content sources 260a-260c. The semantic classifier 654 may generate a signal (e.g., ACC) and/or a signal (e.g., INF) in response to the signal SEMU. The signal ACC may comprise information from the generated content 652 determined to be accurate by the semantic classifier 654. The signal INF may comprise information from the generated content 652 determined to be inferred by the semantic classifier 654.

The semantic classifier 654 may generate the tagged semantic units 656a-656b. The tagged semantic units 656a-656b may be split between verified semantic units 656a (e.g., provided by a signal ACC) and unverified semantic units 656b a signal (e.g., provided by the signal INF). The verified semantic units 656a may comprise the content from the authoritative data source 70 and the unverified semantic units 656b may comprise the inferred content. The tagged semantic units 656a-656b are shown comprising a portion of the semantic units 670a-670n (e.g., tokens corresponding to the semantic units 670a-670i) with a verified metadata tag 680 and another portion of the semantic units 670a-670n (e.g., tokens corresponding to the semantic units 670j-670n) with an unverified metadata tag 682. The verified metadata tag 680 may be used by the downstream process 72 to determine that the semantic units 670a-670i comprise the verified semantic units 656a. The unverified metadata tag 682 may be used by the downstream process 72 to determine that the semantic units 670j-670n comprise the unverified semantic units 656b. The semantic units 670a-670n with the verified metadata tag 680 and the unverified metadata tag 682 may be provided to the downstream process 72. For example, the semantic classifier 654 may generate the signal ACC comprising the verified semantic unit 656a and the signal INF comprising the unverified semantic units 656b, which may be provided to the downstream process 72.

In the example shown, the downstream process 72 may be a reasoning analysis module. For example, the reasoning analysis module may receive a signal (e.g., SPEC) indicating a specification for the output. In some embodiments, the signal SPEC may comprise a template for an output (e.g., similar to the structured output template 202). For example, based on the signal SPEC, the downstream process 72 may fill in content generated by the AI engine 60 based on whether the content may be verified content (e.g., based on the verified metadata tag 680) or unverified content (e.g., based on the unverified metadata tag 682). The downstream process 72 may be downstream of the content pre-filtering system 100. For example, after generating the verified metadata tag 680 and/or the unverified metadata tag 682 for the tokens generated by the AI engine 60, the epistemic tagging control system 650 may not have any effect on how the downstream process 72 operates. The epistemic tagging control system 650 may provide data that may be used (or ignored) by the downstream process 72.

The epistemic tagging control system 650 may classify generated semantic units (e.g., the semantic units 670a-670n) based on an epistemic status determined by the semantic classifier 654 and integrate the classification into downstream reasoning analysis (e.g., the tagged semantic units 656a-656b). The AI engine 60 may receive the prompt in the signal REQUEST and may request additional information from external resources (e.g., the content sources 660a-660c). The authoritative data source 70 may comprise authoritative resources, trusted resources, and unverified resources. The AI engine 60 may generate the semantic units 670a-670n representing portions of the proposed output. The semantic classifier 654 may process the generated semantic units 670a-670n and may assign epistemic classifications such as accurate or inferred. The units classified as accurate (e.g., the verified semantic units 656a) may be associated with verified or authoritative information sources (e.g., tagged with the verified metadata tag 680), while units classified as inferred (e.g., the unverified semantic units 656b) may represent probabilistic reasoning produced by the AI engine 60 (e.g., tagged with the unverified metadata tag 682).

The tagged semantic units 656a-656b may then be passed to a reasoning analysis module (e.g., an example of the downstream process 72) along with an output specification that may define requirements for the requested task. Based on the specification provided in the signal SPEC and the epistemic classification of the tagged semantic units 656a-656b, the reasoning analysis module may determine how the final output may be constructed, including whether inferred content should be permitted, restricted, or excluded. The downstream process 72 may generate a signal (e.g., OUTPUT). The signal OUTPUT may comprise the output that may be generated by the downstream process 72 based on the tagged semantic units 656a-656b but without any direct decision making performed by the content pre-filtering system 100 (e.g., the downstream process 72 may operate independently from the epistemic tagging control system 650 of the content pre-filtering system 100).

The verified metadata tag 680 may provide a label indicating retrieved factual content and the unverified metadata tag 682 may provide a label indicating inferred/generated content. The semantic classifier 654 may attach the verified metadata tag 680 or the unverified metadata tag 682 (and other potential labels, including identifying the trust level of the content sources 660a-660c where the factual content was retrieved from). The downstream process 72 may use the tags to determine whether certain information is acceptable. In one example, a medical system may only accept retrieved factual content. In another example, a research assistant might allow inferred reasoning.

The reasoning engine 72 may filter output based on the epistemic tags of the tagged semantic units 656a-656b. The epistemic tagging control system 650 may provide a truth provenance layer for LLM outputs. Instead of treating all generated text the same, the epistemic tagging control system 650 may enable distinguishing between verified information and model inference. The distinction between verified and inferred may enable the downstream process 72 to enforce accuracy requirements before using the output. The epistemic tagging control system 650 may be useful for legal drafting, medical guidance, financial analysis, academic research tools, safety-critical AI, etc.

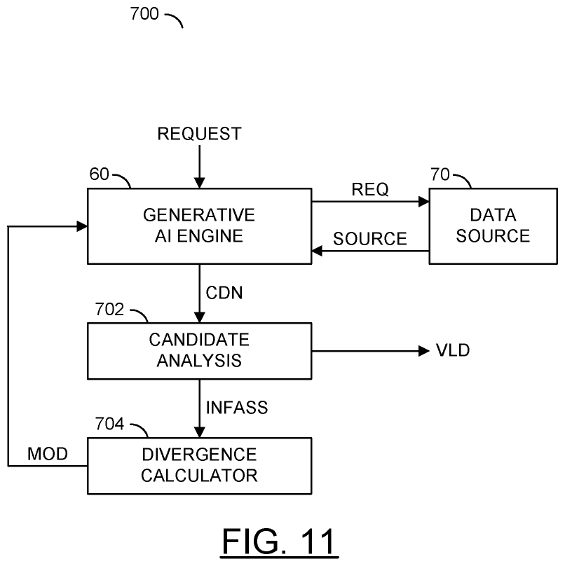

Referring to FIG. 11, a block diagram illustrating inference distance control for probabilistic reasoning systems is shown. An inference distance control system 700 is shown. The inference distance control system 700 may be configured to determine a divergence of data generated by the AI engine 60 from the actual content of information provided by the authoritative data source 70. The amount of divergence may be used to modify an operation of the AI engine 60 and/or may be provided as contextual information for the downstream process 72.

The inference distance control system 700 may comprise the AI engine 60, the authoritative data source 70, a block (or circuit) 702 and/or a block (or circuit) 704. The circuit 702 may implement a candidate analysis module. The circuit 704 may implement a divergence calculator. The inference distance control system 700 may comprise other components (not shown). The number, type and/or arrangement of the components of the inference distance control system 700 may be varied according to the design criteria of a particular implementation.

The inference distance control system 700 may receive the signal REQUEST. The signal REQUEST may be provided to the AI engine 60. For example, the inference distance control system 700 may be an output governance layer implemented by the content pre-filtering system 100. In response to the signal REQUEST, the AI engine 60 may request data elements from the authoritative data source 70. In one example, the AI engine 60 may generate the signal REQ to request data from the authoritative data source 70 and the authoritative data source 70 may provide the signal SOURCE to the AI engine 60 comprising the authoritative data. In another example, the signal SOURCE may be provided as part of the signal REQUEST (e.g., the end user may provide a document that may be the authoritative data source). In yet another example, the content pre-filtering system 100 may receive the signal REQUEST and the data retrieval module 602 may interact with the authoritative data source 70 to retrieve the authoritative data (e.g., as shown in association with FIG. 9).

In response to the signal REQUEST and/or the signal SOURCE, the AI engine 60 may generate candidate reasoning content. Generally, the candidate reasoning content may comprise a combination of authoritative data received from the authoritative data source 70 and probabilistically inferred data generated by the AI engine 60. For example, the AI engine 60 may combine probabilistically inferred data with data received from the authoritative data source 70, and the combination may have varying levels of accuracy. The AI engine 60 may generate a signal (e.g., CDN) in response to the signal REQUEST. The signal CDN may comprise the candidate reasoning content. The signal CDN may be presented to the candidate analysis module 702.

The candidate analysis module 702 may receive the signal CDN. The candidate analysis module 702 may analyze the candidate reasoning content to identify one or more inferred assertions. The inferred assertions may not be explicitly present in the retrieved reference data elements from the authoritative data source 70. In one example, the candidate analysis module 702 may analyze the tokens provided in the candidate reasoning content to determine whether the candidate reasoning content comprises inferred content or authoritative content. In some embodiments, the candidate analysis module 702 may also receive the signal SOURCE in order to provide a ground truth basis for analyzing the candidate reasoning content. The particular method of identifying the inferred assertions performed by the candidate analysis module 702 may be varied according to the design criteria of a particular implementation.

The candidate analysis module 702 may be configured to generate a signal (e.g., VLD) and/or a signal (e.g., INFASS). The signal VLD may comprise valid output. The signal may comprise inferred assertions detected by the candidate analysis module 702. The candidate analysis module 702 may provide the inferred assertions identified to the divergence calculator 704 via the signal INFASS. The candidate analysis module 702 may provide signal VLD as output. For example, the signal VLD may comprise the content that the candidate analysis module 702 has identified as not inferred (e.g., authoritative content). In an example, the signal VLD may be provided to the downstream process 72 and/or the client device 50.

The divergence calculator 704 may be configured to receive the signal INFASS. The divergence calculator 704 may calculate a divergence score for each of the inferred assertions. The divergence score may represent a semantic distance between the inferred assertion and the retrieved reference data elements. In one example, the signal INFASS may comprise the candidate values identified as inferred assertions by the candidate analysis module 702 and the authoritative content provided by the authoritative data source 70. In another example, each token of the inferred assertions may be compared to a reference value to determine the semantic distance. The particular method of calculating the semantic distance for the inferred assertions may be varied according to the design criteria of a particular implementation.

The divergence calculator 704 may compare the divergence score to a predefined divergence threshold. In some embodiments, the predefined divergence threshold may be a pre-registered value (e.g., a stored value that may not be changed). In some embodiments, the predefined divergence threshold may be a user-adjustable parameter. For example, the amount of divergence that the end-user desires as acceptable may be set and stored by the divergence calculator 704. For example, for academic work, the end-user may set a high threshold for the predefined divergence threshold (e.g., the inferred assertions must be identical or nearly identical to the authoritative source data). In another example, for quick work or social media posting, the end-user may set a low threshold for the predefined divergence threshold (e.g., the inferred assertions may be accepted even if there are some errors or inconsistencies). The inferred assertions that exceed the divergence threshold may be constrained according to a modification of the operation of the AI engine 60.

The divergence calculator 704 may generate a signal (e.g., MOD). The signal MOD may comprise a modification for the AI engine 60. The divergence calculator 704 may provide the modification (e.g., via a signal MOD) in response to the divergence score exceeding the divergence threshold. In one example, the modification may comprise a weight value that may increase an importance of the authoritative content. In another example, the modification may comprise additional instructions for analyzing the query in the signal REQUEST. In yet another example, the signal MOD may comprise training data that may be used by the AI engine 60. In still another example, the modification may comprise an uncertainty indicator that the AI engine 60 may apply the output. The signal MOD may be generated in response to the signal INFASS. The particular type of modification provided by the divergence calculator 704 may be varied according to the design criteria of a particular implementation.

The candidate analysis module 702 may generate the output in response to the candidate reasoning content (e.g., valid content) and the modification to the operation of the AI engine 60. The modification to the AI engine 60 provided by the inference distance control system 700 may constrain the inferred assertions by suppressing the inferred assertion, adding an uncertainty indicator to the inferred assertion, and requesting an external validation prior to the output of the inferred assertion, etc.

The inference distance control system 700 may measure how far a generated inference deviates from known source data. The inference distance control system 700 may retrieve reference data, generate reasoning content, detect assertions that may not be explicitly present in the reference data, compute a divergence score representing semantic distance and/or apply controls if the divergence exceeds a threshold. The inference distance control system 700 may provide a hallucination-control mechanism based on semantic distance. Instead of checking whether something is cited, the inference distance control system 700 may measure how far the AI engine 60 extrapolated beyond the data in the authoritative data source 70. The inference distance control system 700 may intervene if the extrapolation exceeds a pre-defined amount. The inference distance control system 700 may be used in AI research tools, regulatory compliance systems, safety-critical analysis, enterprise knowledge assistants, etc. The inference distance control system 700 may function as a reasoning constraint layer applied after candidate reasoning is generated.

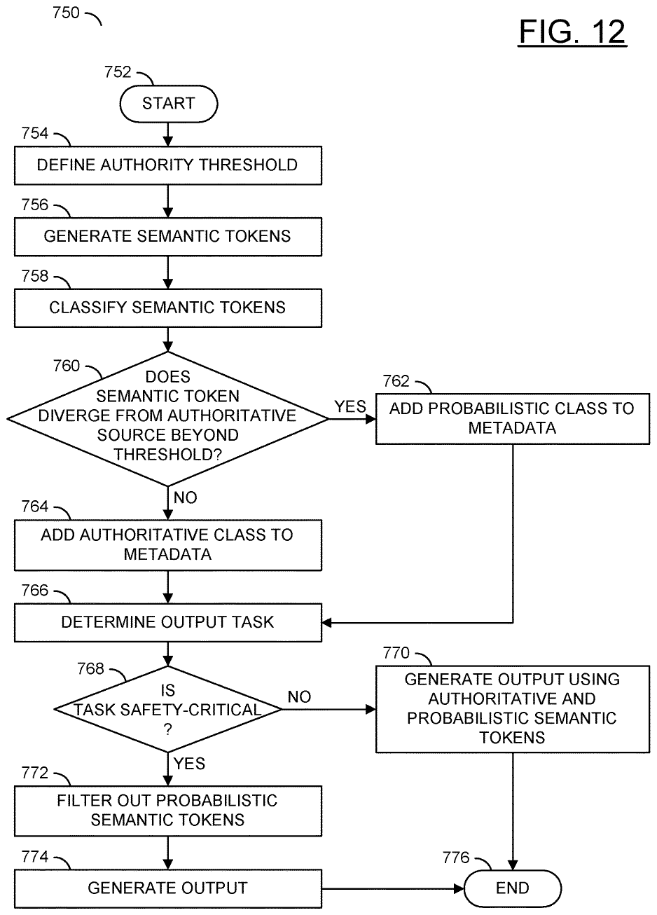

Referring to FIG. 12, a method (or process) 750 is shown. The method 750 may pre-filter output content in response to a divergence from an authoritative source. The method 750 generally comprises a step (or state) 752, a step (or state) 754, a step (or state) 756, a step (or state) 758, a decision step (or state) 760, a step (or state) 762, a step (or state) 764, a step (or state) 766, a decision step (or state) 768, a step (or state) 770, a step (or state) 772, a step (or state) 774, and a step (or state) 776.

The step 752 may start the method 750. In the step 754, the authority threshold may be defined. In an example, the end user may provide the authority threshold as a parameter. The authority threshold may be stored and/or accessed by the semantic classifier 654. Next, in the step 756, the AI engine 60 may generate the semantic tokens. The semantic units 670a-670n may be generated in response to a natural language query provided to the AI engine 60. In the step 758, the semantic classifier 654 may classify the semantic tokens. For example, the semantic classifier 654 may analyze the semantic units 670a-670n content provided in the signal SEMU. Next, the method 750 may move to the decision step 760.

In the decision step 760, the semantic classifier 654 may determine whether the semantic tokens diverge from the authoritative source beyond a threshold amount. For example, the decision step 760 may be performed for each of the semantic units 670a-670n. For the semantic units 670a-670n that do diverge, the method 750 may move to the step 762. In the step 762, the semantic classifier 654 may add the probabilistic class to the metadata. For example, the unverified metadata tag 682 may be added to the semantic units 670j-670n in the unverified tagged semantic units 656b. Next, the method 750 may move to the step 766. In the decision step 760, for the semantic units 670a-670n that do not diverge, the method 750 may move to the step 764. In the step 764, the semantic classifier 654 may add the authoritative class to the metadata. For example, the verified metadata tag 680 may be added to the semantic units 670a-670i in the verified tagged semantic units 656a. Next, the method 750 may move to the step 766. In the step 766, the content pre-filtering system 100 may determine the output task. The output task may be the downstream process 72. Next, the method 750 may move to the decision step 768.

In the decision step 768, the content pre-filtering system 100 may determine whether the task is safety-critical. Whether a task is dependent on ‘safety’ may be one example of a type of task that may require authoritative data. For example, tasks that do not necessarily affect ‘safety’ or may result in harm, may still rely on authoritative data (e.g., legal briefs, academic research, instructions, etc.). If the task is not safety critical, then the method 750 may move to the step 770. In the step 770, the content pre-filtering system 100 may generate output using a combination of authoritative and probabilistic semantic tokens. Next, the method 750 may move to the step 776. In the decision step 768, if the task is safety-critical, then the method 750 may move to the step 772. In the step 772, the content pre-filtering system 100 may filter out the semantic units 670a-670n that have been tagged with the unverified metadata tag 682. Next, in the step 774, the content pre-filtering system 100 may generate output. In some embodiments, the steps 766-774 may be performed by the downstream process 72 rather than the content pre-filtering system 100. For example, the content pre-filtering system 100 may apply the verified metadata tag 680 and/or the unverified metadata tag 682 to the semantic units 670a-670n and may not otherwise affect how the data is used (e.g., decisions on filtering may be performed by the downstream process 72). Next, the method 750 may move to the step 776. The step 776 may end the method 750.

### Differences From Schema-Constrained Generation

Rather than providing validation for output fields, the content pre-filtering system 100 may be configured to actively prevent probabilistic interference from populating the output fields. For example, some systems may define required fields, validate the input, require particular fields before execution, and then populate structured outputs (e.g., form-filling systems, database-driven document generation, workflow engines, API schema validation, etc.). The content pre-filtering system 100 may operate beyond enforcing a schema and/or validating required fields for an output. The content pre-filtering system 100 may prevent the probabilistic interference. While the content pre-filtering system 100 may result in output validation being unnecessary, other systems may perform the output validation on the output of the content pre-filtering system 100, if desired.

### Differences from Retrieval-Augmented Generation (RAG)

Rather than providing a RAG, the content pre-filtering system 100 may remove an authority of the AI engine to generate various values. For example, some systems may implement a RAG by retrieving documents, feeding the documents into the prompt for the AI engine, and/or influence generation. The RAG may add context. However, the content pre-filtering system 100 may be configured to prohibit the AI engine from generating one or more values.

### Differences From Tool/Function Calling

Rather than providing a tool/function calling, the content pre-filtering system 100 may resolve a role deterministically. Modern LLM systems (e.g., OpenAI tools, LangChain, etc.) may allow the AI engine to call external functions. For example, the external functions may operate using patterns such as calling an API to get weather information, and inserting the retrieved data into the response. However, the AI model may determine when to call the tool/function. The content pre-filtering system 100 may determine that a particular role may be resolved deterministically by ensuring that the content provided for particular identified semantic units may not be determined probabilistically.

### Differences From Database-Backed Systems

Rather than providing a database backed system, the content pre-filtering system 100 may mediate between probabilistic token generation and deterministic data binding. For example, some enterprise systems may retrieve a value from a database, validate before execution and/or block transmission if there is data missing. The content pre-filtering system 100 may not merely use a database to populate values, since database backed systems may not operate within probabilistic generative reasoning. The ability to mediate between probabilistic token generate and deterministic data binding may distinguish the content pre-filtering system 100 from database backed systems. The content pre-filtering system 100 may operate above a concept of retrieving data and inserting the data into generated output. The content pre-filtering system 100 may comprise semantic role identification and authoritative data binding to prevent probabilistic substitution and/or block execution when validated data may be missing.

The functions performed by the diagrams of FIGS. 1-12 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. Execution of instructions contained in the computer product by the machine, may be executed on data stored on a storage medium and/or user input and/or in combination with a value generated using a random number generator implemented by the computer product. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROMs (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, cloud servers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

The designations of various components, modules and/or circuits as “a” “n”, when used herein, disclose either a singular component, module and/or circuit or a plurality of such components, modules and/or circuits, with the “n” designation applied to mean any particular integer number. Different components, modules and/or circuits that each have instances (or occurrences) with designations of “a” “n” may indicate that the different components, modules and/or circuits may have a matching number of instances or a different number of instances. The instance designated “a” may represent a first of a plurality of instances and the instance “n” may refer to a last of a plurality of instances, while not implying a particular number of instances.

While the invention has been particularly shown and described with reference to embodiments thereof, it will be understood by those skilled in the art that various changes in form and details may be made without departing from the scope of the invention.

1. A computer-implemented method for enforcing authoritative data binding in a generative machine learning system, the method comprising:
receiving an input comprising (i) a request from an end user associated with a structured output comprising one or more predefined semantic roles and (ii) a data source;
identifying at least one of said predefined semantic roles as an authoritatively bound role prior to execution of said generative machine learning system;
retrieving a value corresponding to said authoritatively bound role from said data source;
populating said authoritatively bound role with said value;
providing said populated authoritatively bound role to said generative machine learning system as part of an execution context for generating said structured output; and
executing said generative machine learning system to generate remaining portions of said structured output while maintaining said populated authoritatively bound role as fixed.

2. The computer-implemented method according to claim 1, wherein said generative machine learning system is permitted to infer values for said predefined semantic roles other than said authoritatively bound role.

3. The computer-implemented method according to claim 1, wherein said generative machine learning system generates narrative content that references said populated authoritatively bound role while preventing modification of said populated authoritatively bound role.

4. The computer-implemented method according to claim 1, wherein said structured output comprises a combination of (i) one or more populated authoritatively bound roles and (ii) probabilistically generated content produced by said generative machine learning system.

5. The computer-implemented method according to claim 1, wherein said generative machine learning system performs probabilistic reasoning using said populated authoritatively bound role as a deterministic parameter.

6. The computer-implemented method according to claim 1, wherein said identifying at least one of said predefined semantic roles as said authoritatively bound role comprises the step of:
analyzing said request from said end user to detect one or more factual assertions, numerical values, or verifiable data elements within a prospective response to said request that are susceptible to authoritative grounding from an external data source.

7. The computer-implemented method according to claim 6, wherein a validation constraint for said authoritatively bound role comprises a recency threshold determined based on whether said authoritatively bound role corresponds to a static historical value or a dynamically changing current value.

8. The computer-implemented method according to claim 1, wherein said data source is stored within a closed system.

9. The computer-implemented method according to claim 8, further comprising the steps of:
maintaining a designation record identifying said closed system as an authoritative source for one or more of said predefined semantic roles;
accessing said closed system via a designated application programming interface in response to said designation record;
storing said value retrieved via said designated application programming interface in a fixed buffer, wherein data stored in said fixed buffer is deemed to be authoritative; and
preventing probabilistic substitution for said data stored in said fixed buffer.

10. The computer-implemented method according to claim 8, wherein said data source stored within said closed system comprises a medical record.

11. The computer-implemented method according to claim 8, further comprising the step of:
blocking said execution of said generative machine learning system when said data source cannot be retrieved from said closed system.

12. The computer-implemented method according to claim 1, wherein said data source comprises a pre-defined data segment supplied by said end user.

13. The computer-implemented method according to claim 12, wherein said pre-defined data segment comprises a selection of text to be reproduced by said generative machine learning system word for word.

14. The computer-implemented method according to claim 12, wherein said authoritatively bound role for said pre-defined data segment is a citation.

15. The computer-implemented method according to claim 1, wherein said data source comprises acquired information retrieved from a third party.

16. The computer-implemented method according to claim 15, wherein said third party is identified by said end user.

17. The computer-implemented method according to claim 15, wherein (i) said third party is a government resource and (ii) said acquired information comprises regulations.

18. The computer-implemented method according to claim 15, further comprising the steps of:
performing an analysis of available resources in response to said authoritatively bound role;
selecting said third party in response to said analysis; and
retrieving said acquired information from said third party selected, wherein said analysis of said available resources comprises determining a trust level ranking for each of said available resources.

19. The computer-implemented method according to claim 15, further comprising the steps of:
generating a question for said end user comprising a list of available resources; and
selecting said third party based on a selection from said list provided by said end user in response to said question.

20. The computer-implemented method according to claim 1, further comprising the step of:
evaluating whether said value satisfies a validation constraint before generating said populated authoritatively bound role.
